(19) United States
(12) Patent Application Publication
(10) Pub. No.: US 2016/0121605 A1
(43) Pub. Date: May 5, 2016

(54) DRIVE APPARATUS FOR LIQUID EJECTION HEAD, LIQUID EJECTION APPARATUS AND INKJET RECORDING APPARATUS

(71) Applicant: FUJIFILM CORPORATION, Tokyo (JP)

(72) Inventor: Baku NISHIKAWA, Ashigarakami-gun (JP)

(73) Assignee: FUJIFILM CORPORATION, Tokyo (JP)

(21) Appl. No.: 14/994,396

(22) Filed: Jan. 13, 2016

Related U.S. Application Data
(62) Division of application No. 14/553,044, filed on Nov. 25, 2014.
Application No. 14/553,044 is a division of application No. 13/403,127, filed on Feb. 23, 2012, now abandoned.

(30) Foreign Application Priority Data
Feb. 24, 2011 (JP) 2011-038909

(51) Int. Cl. B41J 2/045

(52) U.S. Cl. CPC B41J 2/04541; B41J 2/04586

(57) ABSTRACT

A drive apparatus for a liquid ejection head, includes a drive signal generating device for generating a drive signal to operate an ejection energy generating element provided so as to correspond to a nozzle of the liquid ejection head, the drive signal being supplied to the ejection energy generating element so that a liquid droplet is caused to be ejected from the nozzle, wherein: the drive signal includes a plurality of ejection pulses for performing a plurality of ejection operations during one recording period, in a remaining pulse sequence excluding a final pulse of the plurality of ejection pulses, a voltage amplitude of a subsequent pulse is smaller than a voltage amplitude of a preceding pulse, and the final pulse has a largest voltage amplitude, of the plurality of ejection pulses.

This application is a Divisional of copending application Ser. No. 14/553,044, filed on Nov. 25, 2014, which is a Divisional of copending application Ser. No. 13/403,127, filed on Feb. 23, 2012, now abandoned, which claims priority under 35 U.S.C. §119(a) to Application No. 2011-038909, filed in Japan on Feb. 24, 2011, all of which are hereby expressly incorporated by reference into the present application.

### BACKGROUND OF THE INVENTION

1. Field of the Invention

The present invention relates to a drive apparatus which supplies a drive signal for ejecting a liquid droplet from a nozzle of a liquid ejection head typified by an inkjet head, and to a liquid ejection apparatus and an inkjet recording apparatus using such a drive apparatus.

2. Description of the Related Art

The drive waveform for ink ejection in an inkjet printer is required to deposit a desired ink droplet volume at a prescribed position on a recording medium. Therefore, the voltage value must be adjusted appropriately, by taking account of the droplet speed, satellites and mist generating conditions, and the like. Moreover, for an ejection energy generating device (for example, a piezoelectric element) which applies an ejection pressure to pressure chambers corresponding to respective nozzles (ink ejection ports), it is desirable from the viewpoint of device lifespan for the amplitude of the applied voltage to be small.

Japanese Patent Application Publication No. 2001-146011 discloses technology which realizes satellite-free flight of ink by selecting an ink ejection pulse whereby the droplet speed gradually becomes faster when N ink droplets (where N is a natural number not less than 2) are ejected in continuous fashion within one printing period. Furthermore, Japanese Patent Application Publication No. 2001-146011 is composed so as to change the type of droplet (the size of the dot formed by the deposited droplet) by sequentially selecting pulses from a trailing end of a waveform of a reference drive signal which includes N ink ejection pulse signals in one printing period, and applying the pulses to an actuator.

Japanese Patent Application Publication No. 2010-149335 discloses a droplet ejection apparatus which uses a plurality of consecutive drive pulses, ejects droplets in accordance with the number of drive pulses which are applied to a piezoelectric actuator, and causes the droplets to combine into one droplet before arriving at (landing on) a recording medium. Japanese Patent Application Publication No. 2010-149335 proposes a composition in which the pulse interval gradually approaches the intrinsic vibration period (resonance period) Tc, in such a manner that the droplet speed gradually becomes faster, from the leading droplet.

According to the inventions disclosed in Japanese Patent Application Publication No. 2001-146011 and Japanese Patent Application Publication No. 2010-149335, there is no problem with regard to the state of flight of the ejected ink droplets (satellites, misting, etc.), but no consideration is given to the drive voltage. In particular, there remain issues with the related art technology from the perspective that performing ejection with a lower voltage and a is smaller number of pulses contributes to increasing the lifespan of the head.

### SUMMARY OF THE INVENTION

The present invention has been contrived in view of these circumstances, an object thereof being to provide a drive apparatus for a liquid ejection head, a liquid ejection apparatus and an inkjet recording apparatus using the liquid ejection head, in order that an increased lifespan of a head can be achieved while achieving a good state of flight (ejection shape) of an ejected droplet.

In order to achieve the aforementioned object, one aspect of the invention is directed to a drive apparatus for a liquid ejection head, the drive apparatus comprising a drive signal generating device for generating a drive signal to operate an ejection energy generating element provided so as to correspond to a nozzle of the liquid ejection head, the drive signal being supplied to the ejection energy generating element so that a liquid droplet is caused to be ejected from the nozzle, wherein: the drive signal includes a plurality of ejection pulses for performing a plurality of ejection operations during one recording period, in a remaining pulse sequence excluding a final pulse of the plurality of ejection pulses, a voltage amplitude of a subsequent pulse is smaller than a voltage amplitude of a preceding pulse, and the final pulse has a largest voltage amplitude, of the plurality of ejection pulses.

Another aspect of the invention is directed to a drive apparatus for a liquid ejection head, the drive apparatus comprising a drive signal generating device for generating a drive signal to operate an ejection energy generating element provided so as to correspond to a nozzle of the liquid ejection head, the drive signal being supplied to the ejection energy generating element so that a liquid droplet is caused to be ejected from the nozzle, wherein: the drive signal includes a plurality of ejection pulses for performing a plurality of ejection operations during one recording period, and a remaining pulse sequence of the plurality of ejection pulses excluding a final pulse is configured in such a manner that, if the pulses in the remaining pulse sequence are extracted individually and compared in terms of ejection speeds produced by the respective pulses as obtained when used for single-shot ejection, then the ejection speeds produced by subsequent pulses in the remaining pulse sequence are slower than the ejection speeds produced by preceding pulses, and the final pulse causes ejection at a fastest ejection speed, compared with the ejection pulses preceding the final pulse in the remaining pulse sequence.

Another aspect of the invention is directed to a liquid ejection apparatus comprising: a liquid ejection head having a nozzle for ejecting a liquid droplet, a pressure chamber connected to the nozzle, and an ejection energy generating element provided with the pressure chamber; and any one of the drive apparatuses for a liquid ejection head described above causing the liquid droplet to be ejected from the nozzle of the liquid ejection head.

Another aspect of the invention is directed to an inkjet recording apparatus comprising: an inkjet head having a nozzle for ejecting a liquid droplet, a pressure chamber connected to the nozzle, and an ejection energy generating element provided with the pressure chamber; and any one of the drive apparatuses described above for causing the liquid droplet to be ejected from the nozzle of the inkjet head.

Further modes of the present invention will become apparent from the description of the present specification and the drawings.

According to the present invention, if recording of one pixel (one dot) is performed by a plurality of droplets by performing ejection a plurality of times during one recording period, it is possible to reduce the required voltage for realizing a desired droplet volume, without impairing the ejection shape. Accordingly, it is possible to increase the lifespan of the head.

### BRIEF DESCRIPTION OF THE DRAWINGS

FIG. 1 is a waveform diagram showing one example of a drive waveform of an inkjet head according to an embodiment of the present invention;

FIG. 2A shows a state of a nozzle before ejection (steady state) and FIG. 2B is a schematic drawing showing a state during ejection;

FIG. 3 is a waveform diagram of a drive waveform relating to Comparative Example 1;

FIG. 4 is a waveform diagram of a drive waveform relating to Comparative Example 2;

(a) and (b) of FIG. 5 are graphs showing variation in the velocity of the meniscus corresponding to pressure variation due to application of a pull-push waveform;

FIG. 6 is a graph showing a relationship between the pulse width, droplet speed and droplet volume of a square wave relating to a first example of a method of measuring the resonance period Tc;

FIG. 7 is a graph showing a relationship between the pulse interval, droplet speed and droplet volume of a continuous square wave relating to a second example of a method of measuring the resonance period Tc;

FIG. 8 is a waveform diagram showing a concrete example of a drive waveform which is used in an inkjet recording apparatus relating to an embodiment of the present invention;

FIG. 9 is a schematic drawing showing the temporal progression of the state of droplet ejection produced by continuous ejection using the drive waveform in FIG. 8;

FIGS. 10A to 10C are waveform diagrams showing an example of drive waveforms which are used when ejecting droplets at different droplet volumes;

FIG. 11 is a waveform diagram showing a drive waveform for ejecting a large droplet;

FIG. 12 is a waveform diagram showing an example of a drive waveform in which the voltage amplitude and the pulse interval are adjusted in combination;

FIG. 13 is a waveform diagram showing an example of a drive waveform in which the voltage amplitude and the pulse width are adjusted in combination;

FIG. 14 is a waveform diagram showing an example of a drive waveform in which the voltage amplitude and the slope gradient of a pulse are adjusted in combination;

FIG. 15 is a waveform diagram showing an example of a continuous pulse waveform in which the ejection energy is gradually weakened by adjusting the pulse interval;

FIG. 16 is a waveform diagram showing an example of a continuous pulse waveform in which the ejection energy is gradually weakened by adjusting the pulse width;

FIG. 17 is a waveform diagram showing an example of a continuous pulse waveform in which the ejection energy is gradually weakened by adjusting the pulse slope gradient;

FIG. 18 is a block diagram showing an example of the composition of an inkjet recording apparatus which employs a drive apparatus for a liquid ejection head according to an embodiment of the present invention;

FIG. 19 is a general schematic drawing of an inkjet recording apparatus relating to an embodiment of the present invention;

FIGS. 20A and 20B are plan view perspective diagrams showing an example of the composition of an inkjet head;

FIGS. 21A and 21B are plan view perspective diagrams showing further examples of the structure of a head;

FIG. 22 is a cross-sectional diagram along line 22-22 in FIGS. 20A and 20B; and

FIG. 23 is a principal block diagram showing the system composition of an inkjet recording apparatus.

### DESCRIPTION OF THE PREFERRED EMBODIMENTS

Below, embodiments of the present invention are described in detail with reference to the accompanying drawings.

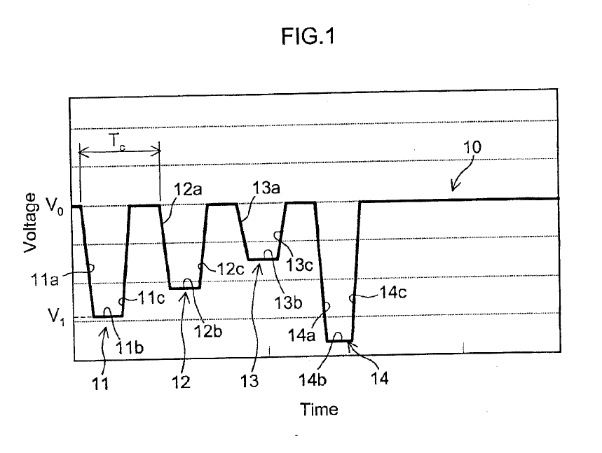

FIG. 1 is a waveform diagram showing one example of a drive waveform of an inkjet head according to an embodiment of the present invention. This drive waveform 10 is a drive waveform in which a plurality of ejection pulses 11 to 14 are provided in consecutive fashion in one recording period during which a dot of one pixel on the recording medium is recorded. Here, the term “one recording period” may also be known in the field as “one printing period” or “one print period”.

FIG. 1 shows an example of a four consecutive shot type where four pulses 11, 12, 13, 14, are provided consecutively. The pulses 11 to 14 are so-called pull-push waveforms, and one ejection action is performed by the application of one pulse. The leading pulse (first to pulse) 11 in the drive waveform 10 is constituted by a first signal element 11a which drives a “pull” operation for deforming a piezoelectric element (not illustrated) in a direction to expand the volume of a pressure chamber connected to a nozzle, a second signal element 11b which maintains (holds) the expanded state of the pressure chamber in a subsequent action, and a third signal element 11c which drives a “push” operation for deforming the piezoelectric element (not illustrated) in a direction to compress the pressure chamber.

The first signal element 11a is a falling waveform portion which reduces the potential from a reference potential V₀. The second signal element 11b is a waveform portion which holds the potential V₁ that has been reduced by the first signal element 11a, and the third signal element 11c is a rising waveform portion which raises the potential (V₁) of the second signal element 11b, to the reference potential.

Following the lead pulse 11, the second pulse 12, the third pulse 13 and the fourth pulse (final pulse) 14 also similarly have signal elements corresponding to “pull”, “hold” and “push” operations. Similarly to the reference numerals 11a, 11b, 11c described in relation to the leading pulse 11, the “pull”, “hold” and “push” signal elements are indicated by applying suffixes “a”, “b” and “c” to the end of the reference numeral indicating the pulses 12 to 14.

In the present specification, for the sake of the description, the potential difference between the second signal elements 11b to 14b of the pulses 11 to 14, and the reference potential, is called the “voltage amplitude” or “wave height”. More specifically, the potential difference (V₀−V₁) between the reference potential V₀ and the potential V₁ of the second signal element 11b is called the “voltage amplitude” or the “wave height” of the first pulse 11. Similarly, the potential differences between the reference potential V₀ and the potential V₂ of the second signal element 12b of the second pulse 12, the potential V₃ of the second signal element 13b of the third pulse 13, and the potential V₄ of the second signal element 14b of the fourth (final) pulse 14, are each called the “voltage amplitude” or the “wave height” of the respective pulses 12 to 14.

In the drive waveform 10 according to the present embodiment, the voltage amplitude (wave height) of the subsequent pulses 12 to 13 is gradually decreased with respect to the voltage amplitude (wave height) of the leading pulse 11, and the voltage amplitude of the final pulse 14 is made larger than the leading pulse 11. More specifically, the voltage amplitude of the final pulse 14 is the largest compared with the voltage amplitudes of the other preceding pulses 11 to 13.

By applying these pulses 11 to 14 to a piezoelectric element, a liquid droplet is ejected from a nozzle, and therefore ejection operations of the same number as the number of ejection pulses included in one recording period are performed in one recording period. In the example in FIG. 1, droplets are ejected in continuous fashion by four consecutive shots in one recording period, and the ejected droplets (4 droplets) combine with each other when they land on the recording medium. One dot is recorded due to the combined droplets (unified droplet) adhering to the recording medium.

One technical approach according to an aspect of the present invention is to make the amplitude of the drive voltage required in order to achieve a certain target droplet volume (a droplet volume for forming one dot), as small as possible, while also satisfying a good flight shape of the ejected droplets, in a continuous pulse waveform.

According to the present embodiment, in order to make the voltage amplitude as small as possible, the first droplet (leading droplet) is pushed out strongly and the subsequent droplets are ejected by utilizing the meniscus vibration (reverberation), whereby the voltage amplitude of the ejection pulses for the subsequent droplets can be reduced. Furthermore, by pushing out the leading droplet strongly, ejection becomes less liable to be affected by the state of the nozzle surface, and the accuracy of the depositing position can also be improved.

This is explained by the following reasons.

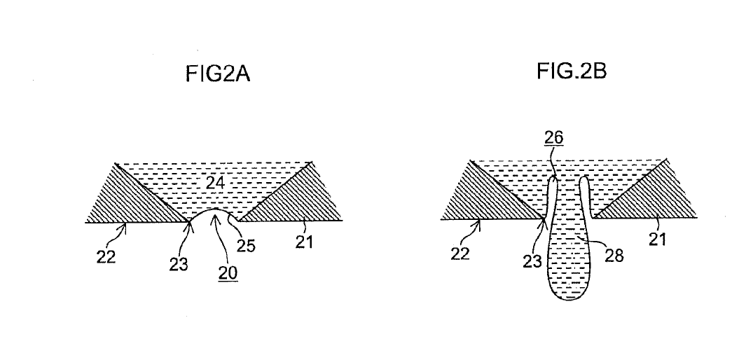

FIG. 2A shows a state of a nozzle before ejection (steady state) and FIG. 2B is a schematic drawing showing a state during ejection. Reference numeral 20 denotes a nozzle aperture, 21 denotes a nozzle plate, 22 denotes a nozzle surface (ejection surface), 23 denotes an edge of the nozzle aperture 20, 24 denotes ink and 25 denotes a meniscus (gas/liquid interface). Although not shown in the drawings, a pressure chamber is provided above the nozzle aperture 20 and a piezoelectric element is provided with the pressure chamber as an ejection energy generating element. By applying a drive voltage to the piezoelectric element, the volume of the pressure chamber is changed, and this change in the volume produces a pressure change which results in liquid being pushed out from the nozzle aperture 20.

In a steady state before ejection shown in FIG. 2A, the ink 24 in the nozzle aperture 20 is maintained at a negative pressure by the back pressure of the head, and the meniscus 25 has a curved surface which is convex toward the pressure chamber side (a concave surface when viewed from the nozzle surface 22 side).

As shown in FIG. 2B, when pushing out the leading droplet, the meniscus 25 is first pulled in by a large extent and then the ink is pushed out, and therefore a dip 26 in the meniscus of a depth corresponding to the initial pull-in amount of the meniscus occurs about the periphery of the pushed out ink (about the periphery of the thread of ink 28). The larger the meniscus pull-in amount due to the initial “pull” operation, the larger (deeper) the dip 26 when the ink is pushed out, and hence a thread of ink 28 is formed at a distant position from the edge 21 of the nozzle aperture 20. Consequently, the ink ejected from the nozzle aperture 20 is not liable to be affected by the nozzle surface 22 about the periphery of the nozzle aperture 20.

It is known that, in a situation where the nozzle surface in the vicinity of the edge 21 of the nozzle aperture 20 is in a poor state, due to soiling of the nozzle surface 22 or degradation of the lyophobic film thereon, for instance, if ink pushed out from the nozzle aperture 20 comes into contact with the degraded nozzle surface, then an ejection direction abnormality (deflection of flight), and the like, occurs, and the depositing position accuracy declines. In this respect, according to the present embodiment, the thread 28 is not liable to touch the nozzle surface 22 and is not liable to be affected by the state of the nozzle surface, and therefore ejection abnormalities such as flight deflection are not liable to occur, and the accuracy of the depositing positions can be maintained even in a situation where the state of the nozzle surface has become degraded to some extent.

Moreover, in the drive waveform 10 shown in FIG. 1, the voltage amplitude of the final pulse 14 is larger than the other preceding pulses (11 to 13), and hence the final droplet can be made to catch up with the preceding droplets which are in flight, combine together with these droplets and then land on the recording medium.

### COMPARATIVE EXAMPLE 1

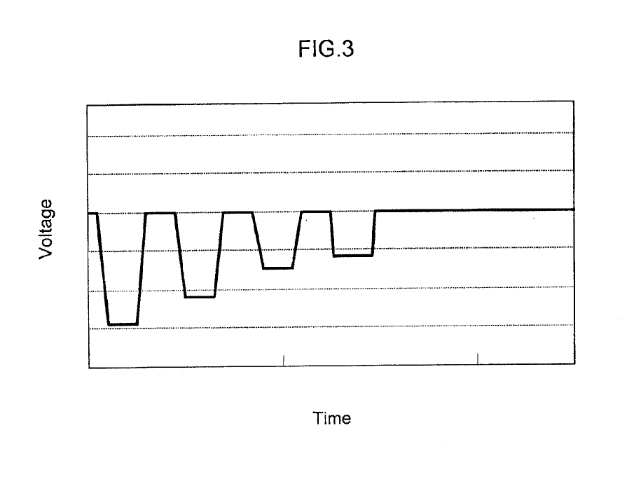

FIG. 3 shows an example of a case where, after strongly pushing out a droplet of the first shot (initial droplet), the push-out force of the subsequent droplets is reduced gradually in the second, third and fourth shots. The difference with respect to FIG. 1 is that the voltage amplitude of the final pulse (fourth-shot pulse) is smaller than the voltage amplitude of the third-shot pulse. In the waveform shown in FIG. 3, it is difficult to make the droplets in the continuous shots combine completely during flight, and a problem occurs in that a main droplet does not join together.

On the other hand, in the waveform in FIG. 1, the voltage amplitude of the final pulse indicated by reference numeral 14 is larger than the preceding pulses (11 to 13). Consequently, it is possible to eject the final droplet more strongly again, and cause this final droplet to merge with the preceding droplets and create a good flight shape.

### COMPARATIVE EXAMPLE 2

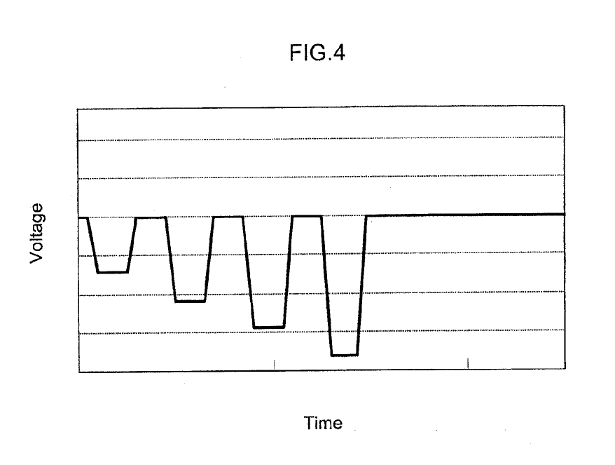

FIG. 4 is a waveform diagram of a further comparative example. As shown in FIG. 4, if a composition is adopted in which the wave height of the subsequent pulses is made gradually larger from the preceding pulse, although the droplet can be made to merge with the preceding droplets, the droplet volume cannot be made sufficiently large. In other words, if the composition in FIG. 1 is achieved by reordering the pulses which constitute FIG. 4, then a larger dot (droplet volume) is achieved in the case of FIG. 1.

This means that in achieving a certain target droplet volume, the drive waveform in FIG. 1 can be set to a low voltage overall, compared with the drive waveform in FIG. 4.

### Pulse Width and Pulse Interval of Ejection Pulse

(a) and (b) of FIG. 5 are graphs showing pressure variation (variation in the meniscus velocity) inside a nozzle (inside a pressure chamber) resulting from application of a typical pull-push waveform in an inkjet head. (a) of FIG. 5 is a waveform representing the pressure variation and (b) of FIG. 5 is a waveform representing the applied drive voltage.

In the case of an inkjet head based on a piezojet method, the ejection mechanism of one nozzle employs a system in which a piezoelectric element is provided with a pressure chamber which is connected to a nozzle aperture (ejection port), a pressure variation is applied to the liquid in the pressure chamber by driving this piezoelectric element, and a liquid droplet is ejected from the nozzle aperture. Since the pressure vibration is used directly for ejection, then desirably, when a droplet is expelled strongly from the nozzle aperture, a pulse waveform having a form corresponding to the sine wave of the pressure vibration is adopted.

In the drive waveform shown in (b) of FIG. 5, when the voltage falls from the reference potential, the pressure chamber swells and therefore the pressure falls and the meniscus inside the nozzle is pulled in the direction of the pressure chamber (the direction opposite to the ejection direction). After starting a pull-in operation of the meniscus by this application of the “pull” waveform element, if the pull voltage is kept uniform, then the meniscus vibrates at an intrinsic vibration period (period of natural vibration) of the vibration system. If the pressure chamber is compressed exactly at the time that the speed of the meniscus again reaches zero (0) again due to the meniscus vibration, then a droplet can be ejected while achieving maximum acceleration. Efficient ejection is possible by adjusting this movement of the meniscus with the pull-push cycle produced by the drive waveform.

As shown in (a) of FIG. 5, since one period of the meniscus vibration is one resonance period Tc, then the best efficiency is achieved by dividing the pulse width at approximately half of this period (Tc/2). Furthermore, the second-shot pulse is desirably set to a pulse interval whereby a pull-push waveform element is superimposed on the pull-in action and accelerating action caused by the vibration of the meniscus produced by the application of the first-shot pulse.

In other words, the pulse interval (the interval from the fall of the preceding pulse until the fall of the next pulse) desirably coincides with the head resonance period (the Helmholtz intrinsic vibration period) Tc, and the pulse width (the time interval from the fall of one pulse until the rise of the pulse) is desirably a fraction (2n−1)/2 of the head resonance period (Helmholtz intrinsic vibration period) Tc (where n is a positive integer).

In the drive waveform 10 illustrated in FIG. 1, the pulse interval is made to coincide substantially with the resonance period Tc, and the pulse width is made to coincide substantially with Tc/2.

### Identifying the Resonance Period Tc

Here, the method of identifying the resonance period Tc will be described. The head resonance period (Helmholtz intrinsic period) Tc is the intrinsic frequency of the whole vibration system which is determined by the ink flow channel system, the ink (acoustic element), and the dimensions, material and physical values of the piezoelectric elements, and the like. The resonance period Tc can be determined by calculation from the head design values (including the physical values of the ink used). Furthermore, the identification method is not limited to a method of deriving from the head design values, and there are also methods for measuring the Tc by experimentation.

### Measurement Method 1:

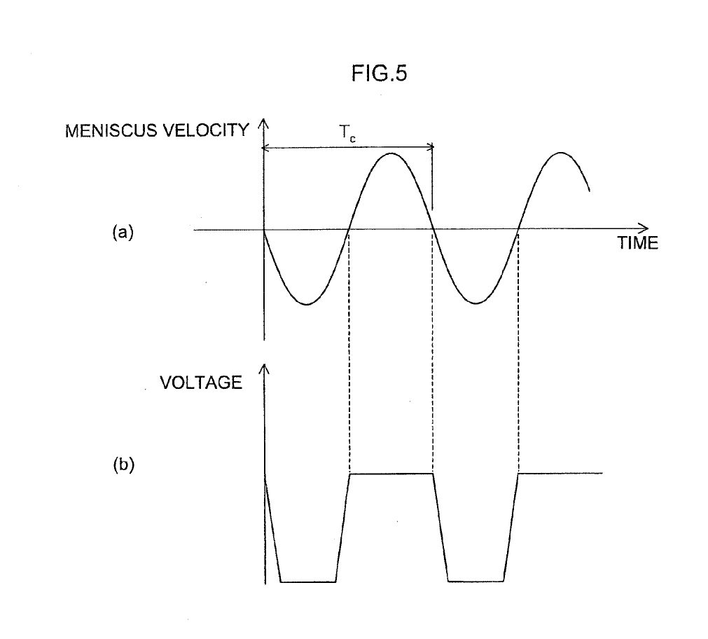

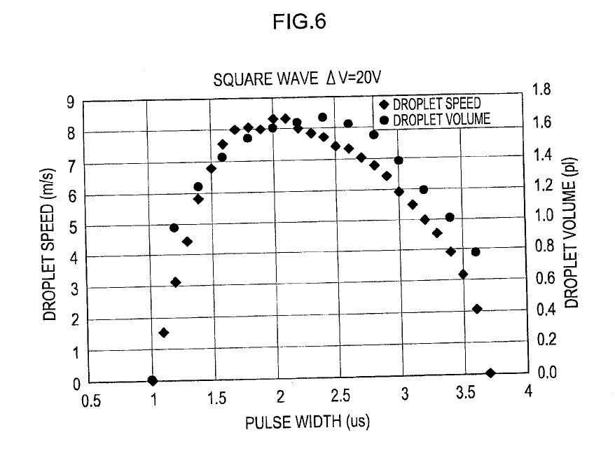

An experiment was carried out to investigate the droplet ejection conditions using a pure simple square wave as a drive waveform. FIG. 6 shows a case where the droplet speed and droplet volume were investigated by gradually altering the pulse width of the square wave. The voltage amplitude ΔV of the square wave was set to 20 V.

In response to the change in the pulse width, the droplet speed and the droplet volume both change in an undulating shape, and have respective peaks where acceleration changes to decrease. In FIG. 6, the peak position of the droplet speed is a position at a pulse width of 2 μs, whereas the peak position of the droplet volume is a position at a pulse width of 2.3 μs, and the respective peak positions are slightly staggered.

In this measurement method 1, the Tc is calculated to be approximately two times the peak position. Calculating from the result of the droplet speed, Tc=4 μs, and calculating from the result of the droplet volume, Tc=4.6 μs.

### Measurement Method 2:

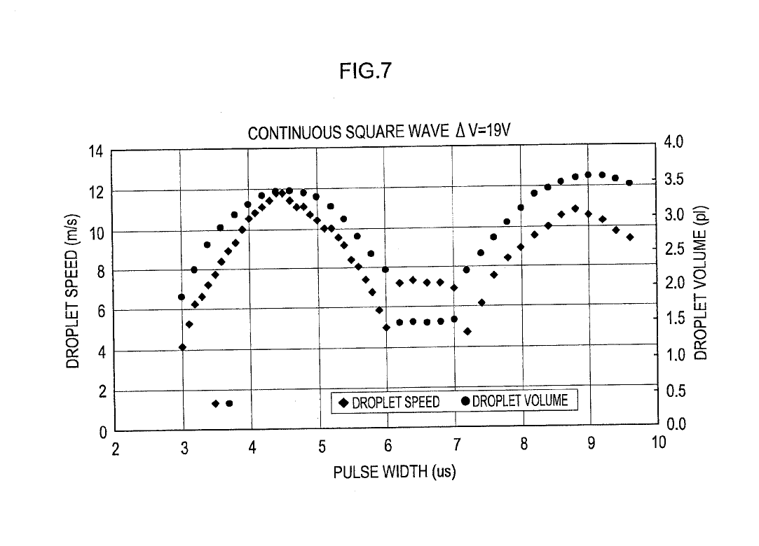

An experiment was carried out to investigate the droplet ejection conditions using a continuous square waveform which included consecutive square waves. FIG. 7 shows a case where the droplet speed and droplet volume were investigated by gradually altering the pulse interval of the continuous square waveform. The voltage amplitude ΔV of the continuous square wave was set to 19 V.

Tc can be understood from the extent to which the droplet speed based on the subsequent pulses becomes faster or the extent of change in the droplet volume, when the pulse interval is varied. As shown in FIG. 7, from the viewpoint of droplet speed and the viewpoint of droplet volume, peaks appeared in roughly the same positions. According to FIG. 7, the peak position is approximately “4.5 μs”. Therefore, according to the measurement method 2, Tc=4.5 μs.

As described in relation to FIG. 6 and FIG. 7, the Tc measurement results vary within a range which depends on the measurement method. In identifying the resonance period Tc, variation in a range depending on the measurement method employed, for instance, deduction (calculation) from the head design values, measurement by the measurement method 1 or 2, etc., should be interpreted as tolerable variation.

### Concrete Examples of Drive Waveform and Behavior of Ejection Operation

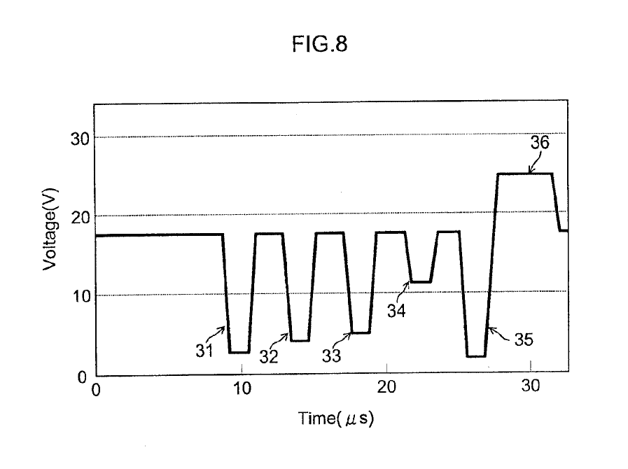

FIG. 8 shows a concrete example of a drive waveform which is used in an inkjet recording apparatus relating to an embodiment of the present invention. The drive waveform 30 in FIG. 8 is composed so as to include five ejection pulses (31 to 35) in one recording period. In the pulse sequence from strongly pushing out an initial droplet by a leading first pulse 31, to the second pulse 32, the third pulse 33 and the fourth pulse 34 following this, the voltage amplitude becomes gradually smaller from the leading pulse 31. The last and fifth pulse (final pulse) 35 has a voltage amplitude greater than the first pulse 31, and ejects a final droplet at a speed whereby the final droplet catches up with the ejected droplets (preceding droplets) produced by the preceding pulses (first to fourth pulses). Furthermore, in the drive waveform 30 according to the present embodiment, a reverberation suppressing (stabilizing) pulse 36 for stabilizing vibration (reverberation) of the meniscus is applied after the fifth pulse 35.

FIG. 9 is a diagram showing a schematic view of the temporal progression of the state of ejection of a droplet produced by application of the drive waveform in FIG. 8. At timing “1” in FIG. 9, liquid of a first shot produced by application of the first pulse 31 is pushed out. At timing “2” in FIG. 9, liquid of a second shot produced by application of the second pulse 32 is pushed out. Thereafter, liquid of a third shot, liquid of a fourth shot and liquid of a fifth shot are pushed out at the respective timings “3”, “4” and “5”.

The subsequent pulses (32 to 35) which are applied after the first pulse 31 accelerate the liquid by using the meniscus vibration (reverberation) caused by the application of the respective preceding pulses. Therefore, the subsequent droplets catch up with the preceding droplets, to the extent that the voltage of the subsequent pulses is slightly reduced with respect to the voltage of the preceding pulses. The second-shot and third-shot droplets in FIG. 9 advance in the thread of the first droplet (leading droplet), and catch up with and combine with the leading droplet.

Furthermore, if the wave height value of the fourth pulse 34 is reduced very greatly with respect to the wave height value of the third pulse 33 (see FIG. 8) as in the case of the fourth-shot droplet, then although the resulting droplet cannot catch up with the preceding droplets, it can merge with the final droplet which is ejected by the final pulse (fifth pulse) 35.

Characteristics of Drive Waveform as Ascertained from Phenomena of Ejection Operation

In the case of continuous pulses as shown in FIG. 8, acceleration is performed using the reverberation (meniscus vibration) caused by preceding pulses, and therefore it is not necessarily possible to identify the droplet speed of the ejected liquid produced by the respective pulses, simply from the relationship between the wave heights of the respective pulses.

However, supposing that the first to fifth pulses are used individually, (if a single-shot ejection is performed by applying a single pull-push pulse), then the droplet speed, ejection force and ejection energy become stronger and weaker in accordance with the wave height value of that pulse.

Consequently, the respective pulses of the remaining pulse sequence excluding the final pulse 35, of the ejection pulses 31 to 35 which constitute the drive waveform 30 as shown in FIG. 8, (namely, the first pulse 31 to the fourth pulse 34) are arranged in such a manner that, if the pulses are respectively used independently, then the ejection speed gradually becomes slower, or the ejection energy gradually becomes smaller, or the ejection force gradually becomes weaker.

Furthermore, the fifth pulse (final pulse) 35 is arranged in such a manner that, if each pulse is used independently, the ejection speed becomes fastest, or the ejection energy becomes greatest, or the ejection force of the fifth pulse 35 becomes strongest, compared with the other preceding pulses (31 to 34).

### Example of Case Where Droplet is Ejected by Varying the Droplet Type

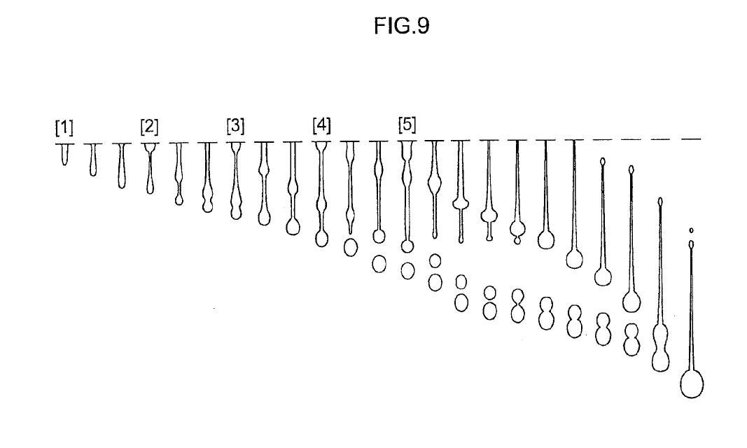

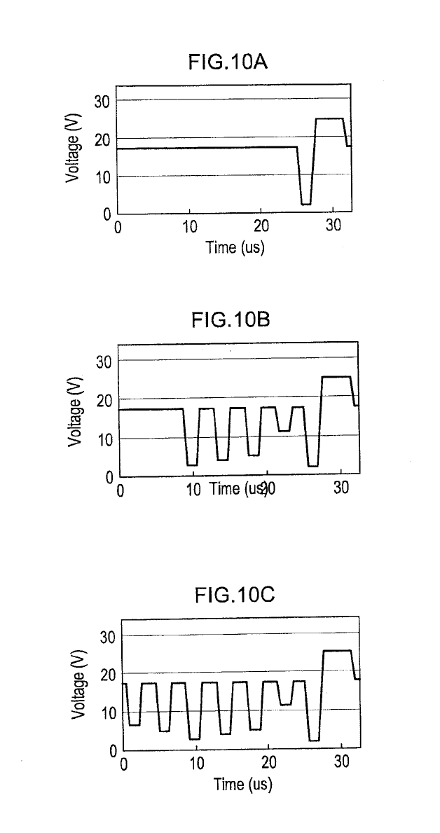

FIGS. 10A to 10C are examples of a drive waveform which is used to eject droplets by varying the droplet volume in one pixel. Here, an example is described in which three droplet sizes, a small droplet, a medium droplet and a large droplet, are ejected selectively by choosing and applying a portion of pulses from the trailing end of a plurality of ejection pulses which constitute a drive waveform of one recording period.

FIG. 10A, FIG. 10B and FIG. 10C are waveform diagrams corresponding respectively to a small droplet, a medium droplet and a large droplet. The composition of the continuous pulse waveform described in relation to FIG. 8 is used for the waveform of a medium droplet (FIG. 10B) which is envisaged to have the highest use frequency. In other words, by adjusting the voltage amplitudes of the respective pulses, a medium droplet is adjusted to achieve ejection efficiency at low voltage. Furthermore, in the final pulse, the compression of the pressure chamber is made stronger than the swelling of the pressure chamber in such a manner that a voltage sufficient to merge with the preceding droplets is ensured. A desirable mode is one where the ejection efficiency of the final pulse is raised by combination with a reverberation suppression portion.

In the small droplet waveform (FIG. 10A), only a final pulse and a reverberation suppressing pulse are selected, from the medium droplet waveform (FIG. 10B) or the large droplet waveform (FIG. 10C).

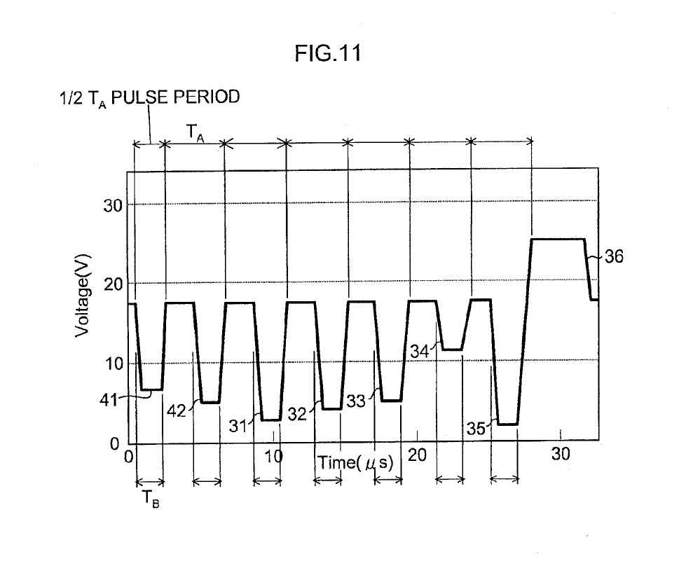

FIG. 11 is a detailed diagram of FIG. 10C. In the large droplet waveform shown in FIG. 11, two pulses (41, 42) are added to (prior to) the front of the medium droplet waveform. The voltage values of the added first pulse 41 and the added second pulse 42 are adjusted in such a manner that the wave height of the added first and second pulses 41, 42 is lower than the first pulse of the medium droplet indicated by reference numeral 31 (the third pulse) and the wave heights of the pulses become gradually higher in the sequence in order of the added first pulse 41, added second pulse 42 and third pulse 31 (i.e. added first pulse 41→added second pulse 42→third pulse 31).

In the case of a medium droplet, with the exception of the final pulse (reference numeral 35), the voltage amplitude of the subsequent pulses after the leading pulse (reference numeral 31) becomes gradually smaller, whereas in the case of a large droplet, a composition is adopted in which the voltage amplitude is gradually increased and the droplet speed is raised, in the portion from the leading pulse (the added first pulse indicated by reference numeral 41) to the third pulse.

The reason for this is as follows. Supposing that, in the case of a large droplet, the voltage amplitudes of the added first pulse 41 and the added second pulse 42 are set to a larger value than the third pulse (reference numeral 31), and voltage adjustment is employed so as to reduce the wave height values of the respective pulses in the range from the added first pulse 41 to the third pulse (reference numeral 31), then the first shot and the second shot are ejected more strongly than the third shot. In this situation, problems occur in that: [1] the ejection speed of the preceding droplets becomes too fast; [2] the droplet volume becomes too large and [3] merging (combination of the droplets) is not possible with the final pulse, and so on. From the viewpoint of avoiding problems of this kind, a waveform such as that shown in FIG. 11 is employed.

In the present embodiment, attention is focused on a waveform for a medium droplet, taking account of the use frequency, and the waveform is designed by applying an embodiment of the present invention in such a manner that a desired droplet volume (5 picoliter, for example) and ejection speed are achieved in line with the design specifications.

For a large droplet, in order to achieve the target droplet volume (for example, 10 picoliter), the waveform of the medium droplet is taken as a reference and additional pulses (reference numerals 41 and 42) as shown in FIG. 11 are added before the medium droplet waveform. If the large droplet waveform is determined on the basis of the medium droplet waveform (main waveform) in this way, then it is relatively easy to align the ejection speeds of the medium droplet and the large droplet.

In the large droplet waveform which is illustrated, the pulse period T_{A} of each ejection pulse (41, 42, 31 to 35) is uniform, and the pulse width T_{B} of each ejection pulse (41, 42, 31 to 35) is uniform.

Furthermore, the small droplet waveform shown in FIG. 10A is contained within the medium droplet waveform (FIG. 10B) and only the final pulse and the reverberation suppressing pulse in the medium droplet waveform are selected. According to the composition of this kind, it is possible to align the droplet speeds (the time taken until the droplet lands on the recording medium) of the small droplet, medium droplet and large droplet.

As described in relation to FIGS. 10A to 10C and FIG. 11, the medium droplet waveform contains the small droplet waveform, and the large droplet waveform contains the medium droplet and small droplet waveforms. In other words, it is possible to change the droplet volume (droplet type) by selectively applying a portion of pulses successively from the trailing end of the large droplet waveform, to the piezoelectric element. In order to align the droplet speeds (ejection speeds) for all of the droplet types and to achieve a target droplet volume for each droplet type, a waveform for a droplet type which is a main type (e.g. the most common) in terms of use frequency, and the like, (in the present example, a medium droplet) is created in accordance with the application of an embodiment of the present invention, and a separate pulse is added in front of this main waveform for a droplet type having a droplet volume exceeding the main droplet type. As illustrated in FIG. 11, the wave height of added pulses gradually becomes larger.

Expansion to More than Three Droplet Types

Here, an example has been described in which droplets of three types are used selectively, but the waveform can also be determined by a similar method in cases where more than three droplet types are used selectively. In other words, a particular droplet type other than a droplet type having a largest droplet volume and a droplet type having a smallest droplet volume is selected as a main droplet type, and the waveform corresponding to this main droplet type (called the “main waveform”) is determined as shown in FIG. 1 to FIG. 8.

In this case, the main waveform contains a waveform of a droplet type which has a smaller droplet volume than the main droplet type. When creating a waveform for a droplet type having a larger droplet volume than this main droplet type, a further pulse is added before the main waveform and this added pulse is set to have a smaller wave height than the leading pulse of the main waveform. Desirably, such added pulses respectively have wave heights which gradually become larger from the first shot. In this way, waveforms for all droplet types are determined. The waveform corresponding to the droplet type of the largest droplet volume contains the waveforms of all droplet types.

There are no particular limitations on the number of ejection pulses in the main waveform and the number of added pulses which are added before the main waveform. It is also possible to obtain a drive waveform corresponding to ejection of a droplet volume which exceeds the droplet volume produced by the main waveform, by also adding M ejection pulses (where M is an integer not less than 1) in front of the main waveform which includes N ejection pulses (where N is an integer not less than 3), within one recording period.

It is possible to eject various droplet volumes by selecting, and supplying to the ejection energy generating element, K ejection pulses (where K is an integer not less than 1 and not more than M+N) from the trailing end of the drive waveform which includes M+N ejection pulses during one recording period.

If a drive waveform of this kind is used in an actual inkjet apparatus, the basic waveform data which contains the waveforms of all droplet types (the data having a waveform corresponding to the droplet type having the largest droplet volume) is incorporated into a storage device, such as a memory, and pulse division information is also held to indicate which number pulse is to be used as the leading pulse for application, with respect to each droplet type. It is also possible to selectively eject droplet types by selecting pulses from the trailing end of the basic waveform (the waveform of the largest droplet volume) which is composed of a plurality of pulses containing waveforms for all droplet types.

For example, ejection pulses which are applied in accordance with the droplet type are selected by controlling a switching element provided on the signal transmission line for applying a drive signal to the ejection energy generating element. In this way, drive voltages having waveforms corresponding to respective droplet types are applied to the piezoelectric elements by using the switching elements which are provided so as to correspond to the respective ejection energy generating elements.

### Further Drive Waveform Examples

In FIG. 1 and FIGS. 8 to 11, an example is described which achieves the target droplet volume and droplet speed, by adjusting the voltage amplitudes of the respective pulses, but it is also possible to achieve a target droplet volume and droplet speed by adjusting the pulse interval, the pulse width and the pulse slopes, in combined fashion, rather than adjusting the voltage amplitude only.

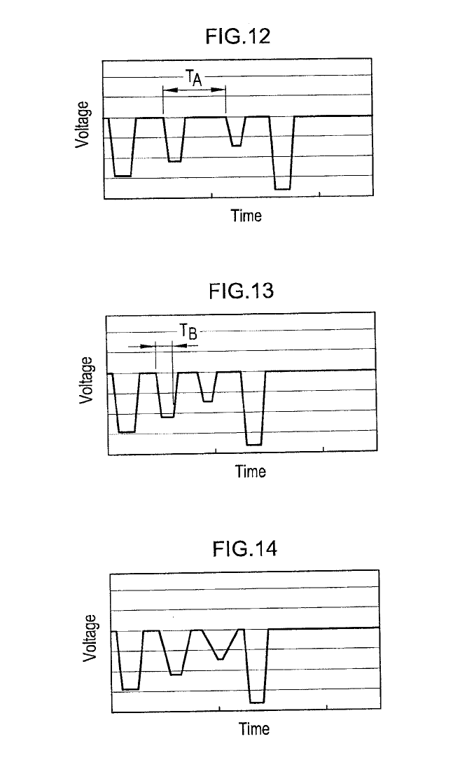

FIG. 12 to FIG. 14 shows a modification example of a drive waveform which is shown in FIG. 1. The drive waveform shown in FIG. 12 is a waveform example which combines adjustment of the voltage amplitude of each pulse, and the adjustment of the pulse interval T_{A}, which are described in relation to FIG. 1. In FIG. 12, a composition is adopted in which the ejection energy is weakened by gradually shifting the pulse interval T_{A} of the subsequent pulses, from the resonance period Tc, in the remaining pulse sequence (reference numerals 11 to 13) excluding the final pulse 14.

It is also possible to shift the pulse interval T_{A} so as to become larger with respect to the resonance period Tc, and it is also possible to shift the pulse interval T_{A} so as to become shorter (decrease) with respect to the resonance period Tc. There are no particular restrictions on the range within which the value is shifted.

The drive waveform shown in FIG. 13 is a waveform example which combines adjustment of the voltage amplitude of each pulse (reference numerals 11 to 14), and the adjustment of the pulse width T_{B}, which are described in relation to FIG. 1. In FIG. 13, a composition is adopted in which the ejection energy is weakened by gradually shifting the pulse width T_{B} of the subsequent pulses, from one half of the resonance period Tc, in the remaining pulse sequence (reference numerals 11 to 13) excluding the final pulse 14. It is also possible to shift the pulse width of the subsequent pulses to as to increase with respect to the leading pulse width, or to shift the pulse width so as to become shorter (decrease) with respect to the leading pulse width. There are no particular restrictions on the range within which the value is shifted.

The drive waveform shown in FIG. 14 is a waveform example which combines adjustment of the slope gradient of the subsequent pulses and adjustment of the voltage amplitude of each pulse (reference numerals 11 to 14) which is described in relation to FIG. 1. In FIG. 14, a composition is adopted in which the ejection energy is weakened by gradually decreasing the slope gradient of the subsequent pulses, in the remaining pulse sequence (reference numerals 11 to 13) excluding the final pulse 14.

According to the compositional example described in FIG. 12 to FIG. 14, further voltage reduction is possible compared with FIG. 1. Furthermore, a composition which appropriately combines the modes in FIG. 12 to FIG. 14 is also possible. In other words, by appropriately combining adjustment of the voltage amplitude, and adjustment of the pulse interval, pulse width and slope gradient, and the like, then the drive waveform which achieves a target droplet volume and droplet speed can be designed even more readily.

### Disclosure of the Related Drive Waveform

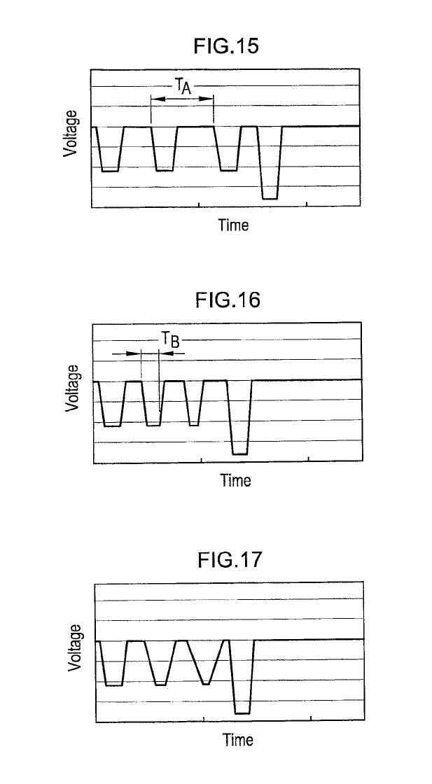

The drive waveforms in FIG. 15 to FIG. 17 are disclosed in relation to the drive waveforms shown in FIG. 12 to FIG. 14.

FIG. 15 to FIG. 17 show cases where the ejection energy of subsequent pulses is weakened by adjusting the pulse interval T_{A}, adjusting the pulse width T_{B} or adjusting the slope gradient of the pulses, without employing adjustment of the voltage amplitudes in the respective pulses (reference numerals 11 to 14) described in relation to FIG. 1.

In FIG. 15, a composition is adopted in which the ejection energy is weakened by gradually shifting the pulse interval T_{A} of the subsequent pulses, from the resonance period Tc, in the remaining pulse sequence excluding the final pulse. In FIG. 16, a composition is adopted in which the ejection energy is weakened by gradually shifting the pulse width T_{B} of the subsequent pulses, from the one half of the resonance period Tc, in the remaining pulse sequence excluding the final pulse.

In FIG. 17, a composition is adopted in which the ejection energy is weakened by gradually decreasing the slope gradient of the subsequent pulses, in the remaining pulse sequence excluding the final pulse.

It is also possible to achieve a target droplet volume or droplet speed by employing a waveform as described in relation to FIG. 15 to FIG. 17, or a suitable combination of these waveforms. Taking account of the perspective of increasing the lifespan of the head by reducing the voltage, the modes illustrated in FIG. 1 and FIG. 10A to FIG. 14 are desirable.

### Example of Composition of Inkjet Recording Apparatus

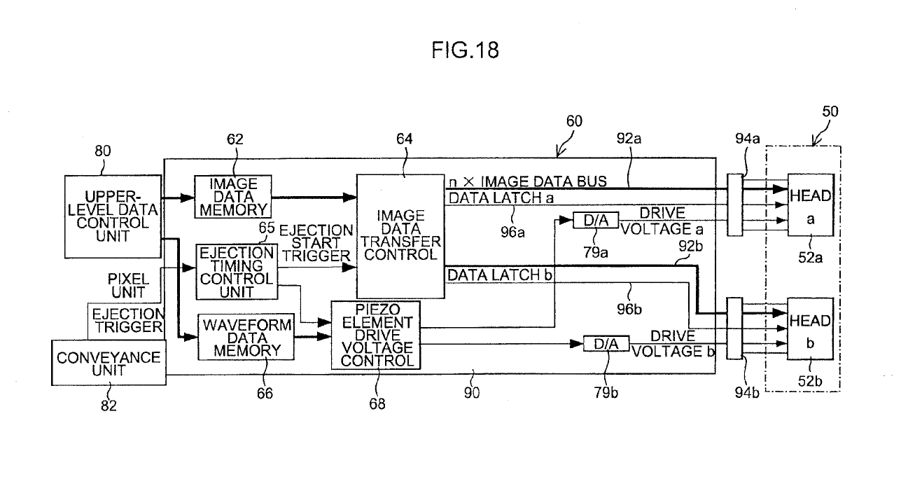

FIG. 18 is a block diagram showing an example of the composition of an inkjet recording apparatus which employs a drive apparatus for a liquid ejection head according to an embodiment of the present invention. The print head (corresponding to the “liquid ejection head”) 50 is composed by combining a plurality of inkjet head modules (hereinafter, called “head modules”) 52a, 52b. Here, in order to simplify the description, two head modules 52a, 52b are depicted, but there is no particular restriction on the number of head modules which constitute one print head 50.

Although the detailed composition of the head modules 52a, 52b is not depicted, a plurality of nozzles (ink ejection ports) are arranged two-dimensionally at high density in the ink ejection surface of each head modules 52a, 52b. Furthermore, ejection energy generating elements (in the present example, piezoelectric elements) corresponding to the respective nozzles are provided in the head modules 52a, 52b.

By joining together a plurality of head modules 52a, 52b in the width direction of the paper (not illustrated) which forms an image formation medium, a long line head (a page-wide head capable of single-pass printing) which has a nozzle row capable of image formation at a prescribed recording resolution (for example, 1200 dpi) through the whole recording range in the paper width direction (the whole possible image formation region) is composed.

The head control unit 60 (which corresponds to a “drive apparatus for a liquid ejection head”) which is connected to the print head 50 functions as a control means for controlling the driving of the piezoelectric elements corresponding to the respective nozzles of the plurality of head modules 52a, 52b, and controlling the ink ejection operation from the nozzles (presence or absence of ejection, droplet ejection volume).

The head control unit 60 includes an image data memory 62, an image data transfer control circuit 64, an ejection timing control unit 65, a waveform data memory 66, a drive voltage control circuit 68 and D/A converters 79a and 79b. In the present embodiment, the image data transfer control circuit 64 includes a “latch signal transmission circuit”, and a data latch signal is output at a suitable timing to the head modules 52a, 52b, from the image data transmission control circuit 64.

Image data which has been developed into image data for printing (dot data) is stored in the image data memory 62. Digital data indicating a voltage waveform of a drive signal (drive waveform) for operating a piezoelectric element is stored in the waveform data memory 66. For example, data of the drive waveform illustrated in FIG. 11 and data indicating pulse divisions, and the like, is stored in the waveform data memory 66. The image data input to the image data memory 62 and the waveform data input to the waveform data memory 66 are managed by an upper-level data control unit 80 (which corresponds to the “upper-level control apparatus”). The upper-level data control unit 80 may be constituted by a personal computer, or a host computer, or the like. The head control unit 60 includes a USB (Universal Serial Bus) or another communication interface as a data communication device for receiving data from the upper-level data control unit 80.

In FIG. 18, in order to simplify the description, only one print head 50 (for one color) is depicted, but in the case of an inkjet recording apparatus including a plurality of print heads respectively for inks of a plurality of colors, a head control unit 60 is provided independently (in head units) in respect of the print head 50 of each color. For example, in a composition which includes print heads for separate colors, corresponding to the four colors of cyan (C), magenta (M), yellow (Y) and black (K), head control units 60 are provided respectively for the print heads of the colors C, M, Y, K, and these head control units of the respective colors are managed by one upper-level data control unit 80.

When the system is started up, waveform data and image data are transferred to the head control units 60 of the respective colors, from the upper-level control unit 80. Data transfer of the image data may be carried out in synchronism with the paper conveyance during the execution of printing. During a printing operation, the ejection timing control units 65 of the respective colors receive an ejection trigger signal from the paper conveyance unit 82, and output a start trigger for starting an ejection operation, to the image data transfer control circuit 64 and the drive voltage control circuit 68. The image data transfer control circuit 64 and the drive voltage control circuit 68 receive this start trigger and carry out a selective ejection operation corresponding to the image data (ejection drive control of a drop-on-demand type) so as to achieve page-wide printing, by transferring waveform data and image data in the resolution units to the head modules 52a, 52b, from the image data transfer control circuit 64 and the drive voltage control circuit 68.

By outputting drive voltage waveform data to the D/A converters 79a, 79b from the drive voltage control circuit 68 in accordance with the print timing signal (ejection trigger signal) input from an external source, the waveform data is converted to analog voltage waveforms by the D/A converters 79a, 79b. The output waveforms (analog voltage waveforms) from the D/A converters 79a, 79b are amplified to a prescribed current and voltage suited to driving the piezoelectric elements, by an amplifier circuit (power amplification circuit), which is not illustrated, and are then supplied to the head modules 52a, 52b.

The image data transfer control circuit 64 can be constituted by a CPU (Central Processing Unit) and an FPGA (Field Programmable Gate Array). The image data transfer control circuit 64 carries out control for transferring nozzle control data for the head modules 52a, 52b (here, image data corresponding to a dot arrangement at the recording resolution) to the head modules 52a, 52b, on the basis of data stored in the image data memory 62. The nozzle control data is image data (dot data) which determines the switching on (ejection driving) and off (no driving) of the nozzles. The image data transfer control circuit 64 controls the opening and closing (ON/OFF switching) of each nozzle by transferring this nozzle control data to the respective head modules 52a, 52b.

The image data transfer paths (reference numerals 92a, 92b) for transferring the nozzle control data output from the image data transfer control circuit 64 to each of the head modules 52a, 52b are called an “image data bus”, “data bus” or “image bus”, or the like, and are constituted by a plurality of signal wires (n wires) (where n≧2). In the present embodiment, these paths are each called a “data bus” (reference numerals 92a, 92b) below. One end of each data bus 92a, 92b is connected to the output terminal (IC pin) of the image data transfer control circuit 64 and the other end of each data bus is connected to a head module 52a, 52b via a connector 94a, 94b which corresponds to each head module 52a, 52b.

The data buses 92a, 92b may be constituted by a copper wire pattern on an electric circuit board 90 on which the image data transfer control circuit 64 and the drive voltage control circuit 68, and the like, are mounted, or it may be constituted by a wire harness, or a combination of these.

The signal wires 96a, 96b of the data latch signals corresponding to the respective head modules 52a and 52b are provided respectively for the head modules 52a and 52b. The data latch signals are sent to the head modules 52a, 52b from the image data transfer control circuits 64, at the required timing, in order that the data signals transferred via the data buses 92a, 92b are set as nozzle data for the head modules 52a, 52b. When a certain volume of image data has been transferred from the image data transfer control circuit 64 to the head modules 52a, 52b via the image data buses 92a, 92b, then a signal called a data latch (latch signal) is sent to the head modules 52a, 52b. The data about the on/off switching of displacement of the piezoelectric elements in each module is established at the timing of the data latch signal. Thereupon, the piezoelectric elements relating to an ON setting are displaced slightly by respectively applying the drive voltages a, b to the head modules 52a, 52b, and ink droplets are ejected accordingly. By applying (depositing) the ink droplets ejected in this way onto paper, printing at a desired resolution (1200 dpi, for instance) is performed. The piezoelectric elements which have been set to off do not produce displacement and do not eject liquid droplets, even if a drive voltage is applied.

A combination of the waveform data memory 66, the drive voltage control circuit 68, the D/A converters 79a, 79b, and the switch elements (not illustrated) for switching the piezoelectric elements corresponding to the nozzles between operation and non-operation, corresponds to the “drive signal generation device”.

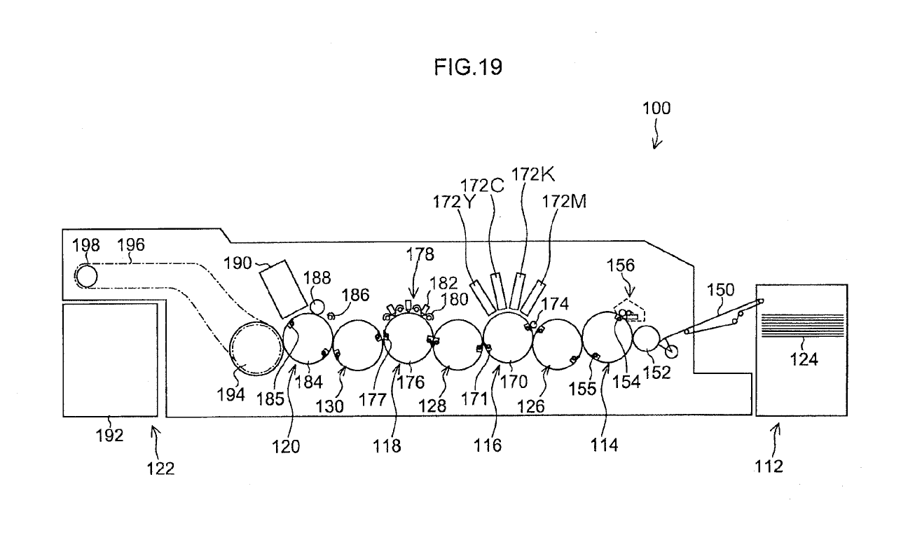

FIG. 19 is a general schematic drawing showing an example of the composition of an inkjet recording apparatus relating to an embodiment of the present invention. The inkjet recording apparatus 100 according to the present embodiment is principally constituted by a paper supply unit 112, a treatment liquid deposition unit (pre-coating unit) 114, an image formation unit 116, a drying unit 118, a fixing unit 120 and a paper output unit 122. The inkjet recording apparatus 100 is a single-pass inkjet recording apparatus which forms a desired color image by ejecting droplets of inks of a plurality of colors from inkjet heads 172M, 172K, 172C and 172Y onto a recording medium 124 (corresponding to a “image formation medium”, also called “paper” below for the sake of convenience) held on a pressure drum (image formation drum 170) of an image formation unit 116. The inkjet recording apparatus 100 is an image forming apparatus of a drop on-demand type employing a two-liquid reaction (aggregation) method in which an image is formed on a recording medium 124 by depositing a treatment liquid (here, an aggregating treatment liquid) on the recording medium 124 before ejecting droplets of ink, and causing the treatment liquid and ink liquid to react together.

### Paper Supply Unit

Cut sheet recording media 124 are stacked in the paper supply unit 112 and a recording medium 124 is supplied, one sheet at a time, to the treatment liquid deposition unit 114, from a paper supply tray 150 of the paper supply unit 112. In the present embodiment, cut sheet paper (cut paper) is used as the recording medium 124, but it is also possible to adopt a composition in which paper is supplied from a continuous roll (rolled paper) and is cut to the required size.

### Treatment Liquid Deposition Unit

The treatment liquid deposition unit 114 is a mechanism which deposits treatment liquid onto a recording surface of the recording medium 124. The treatment liquid includes a coloring material aggregating agent which aggregates the coloring material (in the present embodiment, the pigment) in the ink deposited by the image formation unit 116, and the separation of the ink into the coloring material and the solvent is promoted due to the treatment liquid and the ink making contact with each other.

The treatment liquid deposition unit 114 includes a paper supply drum 152, a treatment liquid drum (also referred to as “pre-coating drum”) 154 and a treatment liquid application apparatus 156. The treatment liquid drum 154 is a drum which holds the recording medium 124 and conveys the medium so as to rotate. The treatment liquid drum 154 includes a hook-shaped gripping device (gripper) 155 provided on the outer circumferential surface thereof, and is devised in such a manner that the leading end of the recording medium 124 can be held by gripping the recording medium 124 between the hook of the holding device 155 and the circumferential surface of the treatment liquid drum 154. The treatment liquid drum 154 may include suction holes provided in the outer circumferential surface thereof, and be connected to a suctioning device which performs suctioning via the suction holes. By this means, it is possible to hold the recording medium 124 tightly against the circumferential surface of the treatment liquid drum 154.

The treatment liquid application apparatus 156 includes a treatment liquid vessel in which treatment liquid is stored, an anilox roller (metering roller) which is partially immersed in the treatment liquid in the treatment liquid vessel, and a rubber roller which transfers a dosed amount of the treatment liquid to the recording medium 124, by being pressed against the anilox roller and the recording medium 124 on the treatment liquid drum 154. In the present embodiment, a composition is described which uses a roller-based application method, but the method is not limited to this, and it is also possible to employ various other methods, such as a spray method, an inkjet method, or the like.

The recording medium 124 onto which treatment liquid has been deposited by the treatment liquid deposition unit 114 is transferred from the treatment liquid drum 154 to the image formation drum 170 of the image formation unit 116 via the intermediate conveyance unit 126.

### Image Formation Unit

The image formation unit 116 includes an image formation drum (also called “jetting drum”) 170, a paper pressing roller 174, and inkjet heads 172M, 172K, 172C and 172Y. The composition of the print head 50 and the composition of the head control unit 60 shown in FIG. 18 are employed as the inkjet heads 172M, 172K, 172C, 172Y of the respective colors and the control apparatus for same.

Similarly to the treatment liquid drum 154, the image formation drum 170 includes a hook-shaped holding device (gripper) 171 on the outer circumferential surface of the drum. A plurality of suction holes (not illustrated) are formed in a prescribed pattern in the circumferential surface of the image formation drum 170, and the recording medium 124 is held by suction on the circumferential surface of the image formation drum 170 by suctioning air from these suction holes. The composition is not limited to one which suctions and holds the recording medium 124 by means of negative pressure suctioning, and it is also possible to adopt a composition which suctions and holds the recording medium 124 by means of electrostatic attraction, for example.

The inkjet heads 172M, 172K, 172C and 172Y are each full-line type inkjet recording heads having a length corresponding to the maximum width of the image forming region on the recording medium 124, and a nozzle row of nozzles (two-dimensionally arranged nozzles) for ejecting ink arranged throughout the whole width of the image forming region is formed in the ink ejection surface of each head. The inkjet heads 172M, 172K, 172C and 172Y are each disposed so as to extend in a direction perpendicular to the conveyance direction of the recording medium 124 (the direction of rotation of the image formation drum 170).

Cassettes of the corresponding color inks (ink cartridges) are installed in the respective inkjet heads 172M, 172K, 172C and 172Y. Ink droplets of the respective inks are ejected from the inkjet heads 172M, 172K, 172C and 172Y toward the recording surface of the recording medium 124 which is held on the outer circumferential surface of the image formation drum 170.

By this means, the ink makes contact with the treatment liquid that has previously been deposited on the recording surface, and the coloring material (pigment) dispersed in the ink is aggregated to form a coloring material aggregate. As one possible example of a reaction between the ink and the treatment liquid, in the present embodiment, bleeding of the coloring material, intermixing between inks of different colors, and interference between ejected droplets due to combination of the ink droplets upon landing are avoided, by using a mechanism whereby an acid is included in the treatment liquid and the consequent lowering of the pH breaks down the dispersion of pigment and causes the pigment to aggregate. In this way, flowing of coloring material, and the like, on the recording medium 124 is prevented and an image is formed on the recording surface of the recording medium 124.

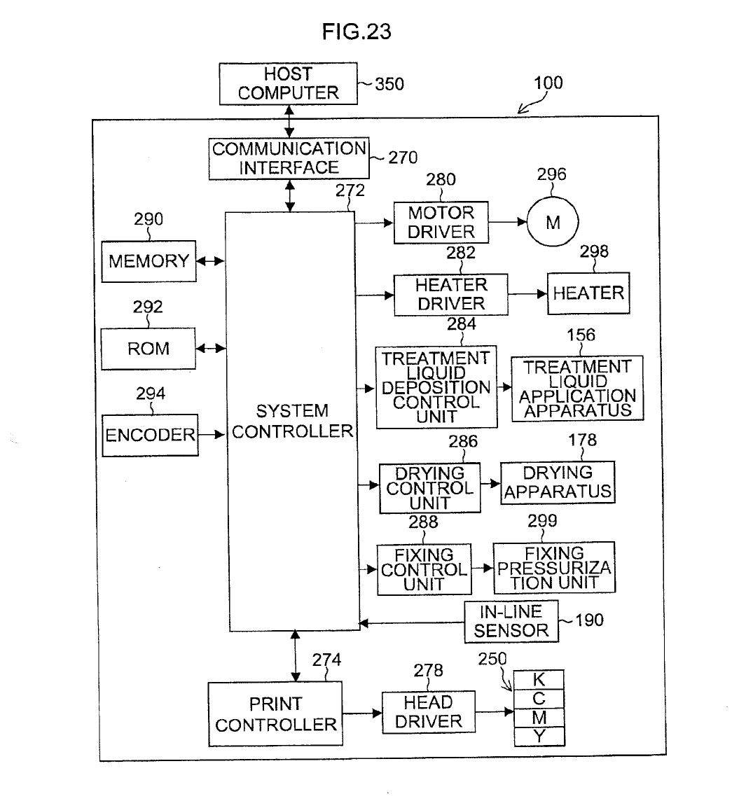

The droplet ejection timings of the inkjet heads 172M, 172K, 172C and 172Y are synchronized with an encoder (not illustrated in FIG. 19; indicated by reference numeral 294 in FIG. 23) which determines the speed of rotation and is provided with the image formation drum 170. An ejection trigger signal (pixel trigger) is issued on the basis of this encoder determination signal. By this means, it is possible to specify the landing position with high accuracy. Moreover, speed variations caused by inaccuracies in the image formation drum 170, or the like, can be ascertained in advance, and the droplet ejection timings obtained by the encoder can be corrected, thereby reducing droplet ejection non-uniformities, irrespectively of inaccuracies in the image formation drum 170, the accuracy of the rotational axle, and the speed of the outer circumferential surface of the image formation drum 170. Furthermore, maintenance operations such as cleaning the nozzle surfaces of the inkjet heads 172M, 172K, 172C and 172Y, discharging ink of increased viscosity, and the like, is desirably carried out with the head unit withdrawn from the image formation drum 170.

Although the configuration with the CMYK standard four colors is described in the present embodiment, combinations of the ink colors and the number of colors are not limited to those. As required, light inks, dark inks and/or special color inks can be added. For example, a configuration in which inkjet heads for ejecting light-colored inks such as light cyan and light magenta are added is possible. Moreover, there are no particular restrictions on the sequence in which the heads of respective colors are arranged.

The recording medium 124 onto which an image has been formed in the image formation unit 116 is transferred from the image formation drum 170 to the drying drum 176 of the drying unit 118 via the intermediate conveyance unit 128.

### Drying Unit

The drying unit 118 is a mechanism which dries the water content contained in the solvent which has been separated by the action of aggregating the coloring material, and includes a drying drum 176 and a solvent drying apparatus 178. Similarly to the treatment liquid drum 154, the drying drum 176 includes a hook-shaped holding device (gripper) 177 provided on the outer circumferential surface of the drum in such a manner that the leading end of the recording medium 124 can be held by the holding device 177.

The solvent drying apparatus 178 is disposed in a position opposing the outer circumferential surface of the drying drum 176, and has a plurality of halogen heaters 180 and hot air spraying nozzles 182 disposed respectively between the halogen heaters 180. It is possible to achieve various drying conditions, by suitably adjusting the temperature and air flow volume of the hot air flow which is blown from the hot air flow spraying nozzles 182 toward the recording medium 124, and the temperatures of the respective halogen heaters 180. The recording medium 124 on which a drying process has been carried out in the drying unit 118 is transferred from the drying drum 176 to the fixing drum 184 of the fixing unit 120 via the intermediate conveyance unit 130.

### Fixing Unit

The fixing unit 120 includes a fixing drum 184, a halogen heater 186, a fixing roller 188 and an in-line sensor 190. Similarly to the treatment liquid drum 154, the fixing drum 184 includes a hook-shaped holding device (gripper) 185 provided on the outer circumferential surface of the drum, in such a manner that the leading end of the recording medium 124 can be held by the holding device 185.

By means of the rotation of the fixing drum 184, the recording medium 124 is conveyed with the recording surface facing to the outer side, and preliminary heating by the halogen heater 186, a fixing process by the fixing roller 188 and inspection by the in-line sensor 190 are carried out in respect of the recording surface.

The fixing roller 188 is a roller member for applying heat and pressure to the dried ink so as to melt self-dispersing polymer micro-particles contained in the ink and thereby cause the ink to form a film, and is composed so as to heat and pressurize the recording medium 124. By this means, the recording medium 124 is sandwiched between the fixing roller 188 and the fixing drum 184 and is nipped with a prescribed nip pressure (for example, 0.15 MPa), whereby a fixing process is carried out.

Furthermore, the fixing roller 188 is constituted by a heating roller formed by a metal pipe of aluminum, or the like, having good thermal conductivity, which internally incorporates a halogen lamp, and is controlled to a prescribed temperature (for example, 60° C. to 80° C.). By heating the recording medium 124 by means of this heating roller, thermal energy equal to or greater than the Tg temperature (glass transition temperature) of the latex contained in the ink is applied and the latex particles are thereby caused to melt. By this means, fixing is performed by pressing the latex particles into the undulations in the recording medium 124, as well as leveling the undulations in the image surface and obtaining a glossy finish.

The in-line sensor 190 is a reading device for determining an ejection failure checking pattern, the density, and a defect in an image (including a test pattern) recorded on a recording medium 124, and a CCD line sensor or the like is employed for the in-line sensor 190.

According to the fixing unit 120 having the composition described above, the latex particles in the thin image layer formed by the drying unit 118 are heated, pressurized and melted by the fixing roller 188, and hence the image layer can be fixed to the recording medium 124.

Instead of an ink which includes a high-boiling-point solvent and polymer micro-particles (thermoplastic resin particles), it is also possible to include a monomer which can be polymerized and cured by exposure to ultraviolet (UV) light. In this case, the inkjet recording apparatus 100 includes a UV exposure unit for exposing the ink on the recording medium 124 to UV light, instead of a heat and pressure fixing unit (fixing roller 188) based on a heat roller. In this way, if using an ink containing an active light-curable resin, such as an ultraviolet-curable resin, a device which irradiates the active light, such as a UV lamp or an ultraviolet LD (laser diode) array, is provided instead of the fixing roller 188 for heat fixing.

### Paper Output Unit

A paper output unit 122 is provided subsequently to the fixing unit 120. The paper output unit 122 includes an output tray 192, and a transfer drum 194, a conveyance belt 196 and a tensioning roller 198 are provided between the output tray 192 and the fixing drum 184 of the fixing unit 120 so as to oppose same. The recording medium 124 is sent to the conveyance belt 196 by the transfer drum 194 and output to the output tray 192. The details of the paper conveyance mechanism created by the conveyance belt 196 are not shown, but the leading end portion of a recording medium 124 after printing is held by a gripper on a bar (not illustrated) which spans across the endless conveyance belt 196, and the recording medium is conveyed above the output tray 192 due to the rotation of the conveyance belts 196.

Furthermore, although not shown in FIG. 19, the inkjet recording apparatus 100 according to the present embodiment includes, in addition to the composition described above, an ink storing and loading unit which supplies ink to the inkjet heads 172M, 172K, 172C and 172Y, and a device which supplies treatment liquid to the treatment liquid deposition unit 114, as well as including a head maintenance unit which carries out cleaning (nozzle surface wiping, purging, nozzle suctioning, and the like) of the inkjet heads 172M, 172K, 172C and 172Y, a position determination sensor which determines the position of the recording medium 124 in the paper conveyance path, and a temperature sensor which determines the temperature of the respective units of the apparatus, and the like.

### Example of Composition of Inkjet Head

Next, the structure of the inkjet head will be described. The inkjet heads 172M, 172K, 172C and 172Y corresponding to the respective colors have a common structure, and therefore these heads are represented by a head indicated by the reference numeral 250 below.

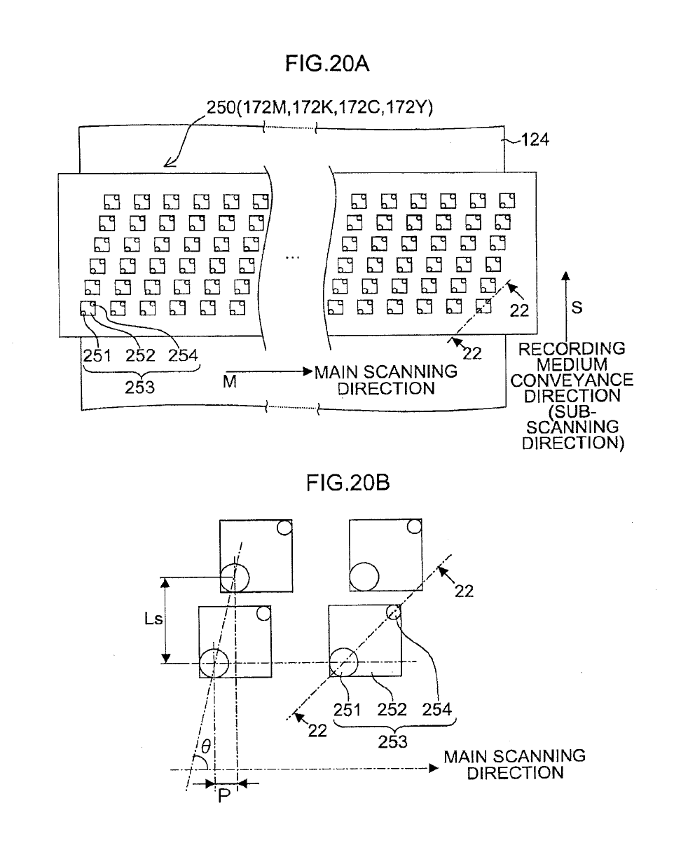

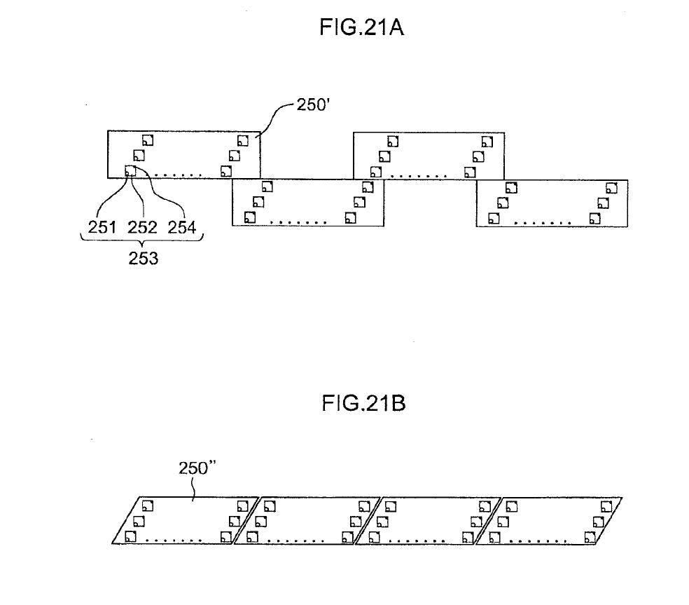

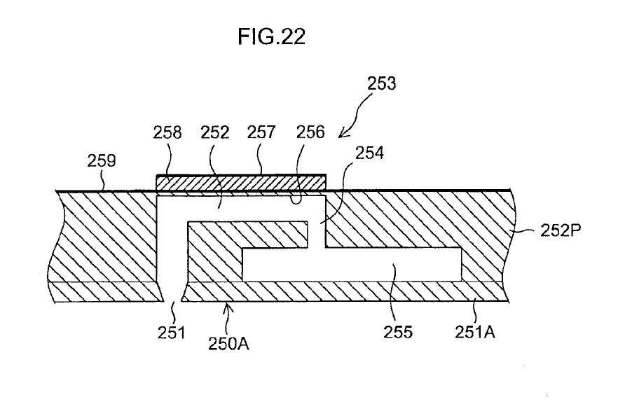

FIG. 20A is a plan view perspective diagram showing an example of the structure of a head 250, and FIG. 20B is a partial enlarged view of same. FIGS. 21A and 21B are diagrams showing examples of the arrangement of a plurality of head modules which constitute a head 250. Furthermore, FIG. 22 is a cross-sectional diagram (a cross-sectional diagram along line 22-22 in FIGS. 20A and 20B) showing a composition of a droplet ejection element of one channel (an ink chamber unit corresponding to one nozzle 251) which forms a recording element unit (ejection element unit).

As shown in FIGS. 20A and 20B, the head 250 according to this example has a structure in which a plurality of ink chamber units (droplet ejection elements) 253 are arranged two-dimensionally in a matrix configuration, each ink chamber unit including a nozzle 251 forming an ink ejection port, and a pressure chamber 252 corresponding to the nozzle 251, and the like, whereby a high density is achieved in the effective nozzle pitch (projected nozzle pitch) obtained by projecting (by orthogonal reflection) the nozzles to an alignment in the lengthwise direction of the head (the direction perpendicular to the paper conveyance direction).

In order to compose a nozzle row equal to or greater than a length corresponding to the full width Wm of the image forming region of the recording medium 124 in a direction (the direction of arrow M; corresponding to a “second direction”) which is substantially perpendicular to the conveyance direction of the recording medium 124 (the direction of arrow S; corresponding to a “first direction”), a long line type head is composed by arranging short head modules 250′ in a staggered configuration, each short head module 250′ having a plurality of nozzles 251 arranged two-dimensionally, as shown in FIG. 21A, for example. Alternatively, as shown in FIG. 21B, it is also possible to adopt a mode where head modules 250″ are joined together in one row. The head modules 250′ or 250″ shown in FIGS. 21A and 21B correspond to the head modules 52a, 52b illustrated in FIG. 18.

The full-line print head for single-pass printing is not limited to a case where the full surface of the recording medium 124 is taken as the image formation range, and in cases where a portion of the surface of the recording medium 124 is taken as the image formation region (for example, a case where a non-image formation region (blank margin portion) is provided at the periphery of the paper, or the like), then nozzle rows required for image formation in the prescribed image formation range should be formed.

The pressure chambers 252 provided to correspond to the respective nozzles 251 have a substantially square planar shape (see FIG. 20A and FIG. 20B), an outlet port to the nozzle 251 being provided in one corner of a diagonal of the pressure chamber, and an ink inlet port (supply port) 254 being provided in the other corner thereof. The shape of the pressure chambers 252 is not limited to that of the present example and various modes are possible in which the planar shape is a quadrilateral shape (diamond shape, rectangular shape, or the like), a pentagonal shape, a hexagonal shape, or other polygonal shape, or a circular shape, elliptical shape, or the like.

As shown in FIG. 22, the head 250 (head module 250′, 250″) has a structure in which a nozzle plate 251A in which nozzles 251 are formed, a flow channel plate 252P in which flow channels such as pressure chambers 252 and a common flow channel 255, and the like, are formed, and so on, are layered and bonded together. The nozzle plate 251A constitutes the nozzle surface (ink ejection surface) 250A of the head 250 and a plurality of nozzles 251 which are connected respectively to the pressure chambers 252 are formed in a two-dimensional configuration therein.

The flow channel plate 252P is a flow channel forming member which constitutes side wall portions of the pressure chambers 252 and in which a supply port 254 is formed to serve as a restricting section (most constricted portion) of an individual supply channel for guiding ink to each pressure chamber 252 from the common flow channel 255. For the sake of the description, a simplified view is given in FIG. 22, but the flow channel plate 252P has a structure formed by layering together one or a plurality of substrates.

The nozzle plate 251A and the flow channel plate 252P can be processed into a required shape by a semiconductor manufacturing process using silicon as a material.

The common flow channel 255 is connected to an ink tank (not shown), which is a base tank that supplies ink, and the ink supplied from the ink tank is supplied through the common flow channel 255 to each of the pressure chambers 252.

Piezo actuators (piezoelectric elements) 258 each including an individual electrode 257 are bonded to a diaphragm 256 which constitutes a portion of the surfaces of the pressure chambers 252 (the ceiling surface in FIG. 22). The diaphragm 256 according to the present embodiment is made of silicon (Si) having a nickel (Ni) conducting layer which functions as a common electrode 259 corresponding to the lower electrodes of the piezo actuators 258, and serves as a common electrode for the piezo actuators 258 which are arranged so as to correspond to the respective pressure chambers 252. A mode is also possible in which a diaphragm is made from a non-conductive material, such as resin, and in such a case, a common electrode layer made of a conductive material, such as metal, is formed on the surface of the diaphragm material. Furthermore, the diaphragm which also serves as a common electrode may be made of a metal (conductive material), such as stainless steel (SUS), or the like.

When a drive voltage is applied to an individual electrode 257, the corresponding piezo actuator 258 deforms, thereby changing the volume of the pressure chamber 252. This causes a pressure change which results in ink being ejected from the nozzle 251. When the piezo actuator 258 returns to its original state after ejecting ink, the pressure chamber 252 is replenished with new ink from the common flow channel 255 via the supply port 254.

The high-density nozzle head of the present embodiment is achieved by arranging a plurality of ink chamber units 253 having a structure of this kind, in a lattice configuration according to a prescribed arrangement pattern in a row direction following the main scanning direction and an oblique column direction having a prescribed non-perpendicular angle θ with respect to the main scanning direction, as shown in FIG. 20B. If the pitch between adjacent nozzles in the sub-scanning direction is taken to be Ls, then this matrix arrangement can be treated as equivalent to a configuration where nozzles 251 are effectively arranged in a single straight line at a uniform pitch of P=Ls/tan θ apart in the main scanning direction.

Furthermore, in implementing an embodiment of the present invention, the mode of arrangement of the nozzles 251 in the head 250 is not limited to the example shown in the drawings, and it is possible to adopt various nozzle arrangements. For example, instead of the matrix arrangement shown in FIGS. 20A and 20B, it is possible to use a bent line-shaped nozzle arrangement, such as a V-shaped nozzle arrangement, or a zig-zag shape (W shape, or the like) in which a V-shaped nozzle arrangement is repeated.

The device for generating ejection pressure (ejection energy) for ejecting droplets from the nozzles in the inkjet head is not limited to a piezo actuator (piezoelectric element), and it is also possible to employ pressure generating elements (ejection energy generating elements) of various types, such as an electrostatic actuator, a heater in a thermal method (a method which ejects ink by using the pressure created by film boiling upon heating by a heater) or actuators of various kinds based on other methods. A corresponding energy generating element is provided in the flow channel structure in accordance with the ejection method of the head.

### Description of Control System

FIG. 23 is a block diagram showing the main configuration of a system of the inkjet recoding apparatus 100. The inkjet recording apparatus 100 includes a communication interface 270, a system controller 272, a print controller 274, an image buffer memory 276, a head driver 278, a motor driver 280, a heater driver 282, a treatment liquid deposition control unit 284, a drying control unit 286, a fixing control unit 288, a memory 290, a ROM 292, an encoder 294 and the like.

The communication interface 270 is an interface unit for receiving image data sent from a host computer 350. A serial interface such as USB (Universal Serial Bus), IEEE1394, Ethernet (registered trademark), and wireless network, or a parallel interface such as a Centronics interface may be used as the communication interface 270. A buffer memory (not shown) may be mounted in this portion in order to increase the communication speed. The image data sent from the host computer 350 is received by the inkjet recording apparatus 100 through the communication interface 270, and is temporarily stored in the memory 290.

The memory 290 is a storage device for temporarily storing images inputted through the communication interface 270, and data is written and read to and from the memory 290 through the system controller 272. The memory 290 is not limited to a memory composed of semiconductor elements, and a hard disk drive or another magnetic medium may be used.

The system controller 272 is constituted of a central processing unit (CPU) and peripheral circuits thereof, and the like, and it functions as a control device for controlling the whole of the inkjet recording apparatus 100 in accordance with a prescribed program, as well as a calculation device for performing various calculations. More specifically, the system controller 272 controls the various sections, such as the communication interface 270, print controller 274, motor driver 280, heater driver 282, treatment liquid deposition control unit 284 and the like, as well as controlling communications with the host computer 350 and writing and reading to and from the memory 290, and it also generates control signals for controlling the motor 296 of the conveyance system and heater 298.

Programs executed by the CPU of the system controller 272, the various types of data which are required for control procedures, and the like, are stored in the ROM 292. The ROM 292 may be a non-writeable storage device, or it may be a rewriteable storage device, such as an EEPROM. The memory 290 is utilized as a temporary storage area of the image data, and also utilized as an expansion (development) area of the program and a calculation operation area of the CPU.

The motor driver 280 is a driver which drives the motor 296 in accordance with instructions from the system controller 272. In FIG. 23, various motors arranged in the respective units of the apparatus are represented by the reference numeral 296. For example, the motor 296 shown in FIG. 23 includes motors which drive the rotation of the paper supply drum 152, the treatment liquid drum 154, the image formation drum 170, the drying drum 176, the fixing drum 184, the transfer drum 194, and the like, shown in FIG. 19, and a drive motor of the pump for suctioning at a negative pressure from the suction holes of the image formation drum 170, a motor for a withdrawal mechanism which moves the head units of the inkjet heads 172M, 172K, 172C and 172Y to a maintenance area apart from the image formation drum 170, and the like.

The heater driver 282 is a driver which drives the heater 298 in accordance with instructions from the system controller 272. In FIG. 23, various heaters arranged in the respective units of the apparatus are represented by the reference numeral 298. For example, the heater 298 shown in FIG. 23 includes a pre-heater (not illustrated) for previously heating the recording medium 124 to a suitable temperature in the paper supply unit 112.

The print controller 274 has a signal processing function for performing various tasks, compensations, and other types of processing for generating print control signals from the image data stored in the memory 290 in accordance with commands from the system controller 272 so as to supply the generated print data (dot data) to the head driver 278.

In general, the dot data is generated by subjecting the multiple-tone image data to color conversion processing and half-tone processing. The color conversion processing is processing for converting image data represented by a sRGB system, for instance (for example, 8-bit RGB color image data) into image data of the respective colors of ink used by the inkjet recording apparatus 100 (KCMY color data, in the present embodiment).

Half-tone processing is processing for converting the color data of the respective colors generated by the color conversion processing into dot data of respective colors (in the present embodiment, KCMY dot data) by error diffusion or a threshold matrix method, or the like.

Required signal processing is carried out in the print controller 274, and the ejection amount and the ejection timing of the ink droplets from the respective print heads 250 are controlled via the head driver 278, on the basis of the obtained dot data. By this means, desired dot size and dot positions can be achieved. Here, the dot data corresponds to “nozzle control data”

An image buffer memory (not shown) is provided in the print controller 274, and image data, parameters, and other data are temporarily stored in the image buffer memory when image data is processed in the print controller 274. Also possible is a mode in which the print controller 274 and the system controller 272 are integrated to form a single processor.

To give a general description of the sequence of processing from image input to print output, image data to be printed (original image data) is inputted from an external source through the communication interface 270, and is accumulated in the memory 290. At this stage, RGB image data is stored in the memory 290, for example. In this inkjet recording apparatus 100, an image which appears to have a continuous tonal graduation to the human eye is formed by changing the deposition density and the dot size of fine dots created by ink (coloring material), and therefore, it is necessary to convert the input digital image into a dot pattern which reproduces the tonal graduations of the image (namely, the light and shade toning of the image) as faithfully as possible. Therefore, original image data (RGB data) stored in the memory 290 is sent to the print controller 274, through the system controller 272, and is converted to the dot data for each ink color by half-tone processing using a threshold matrix method, an error diffusion method or the like. In other words, the print controller 274 performs processing for converting the input RGB image data into dot data for the four colors of K, C, M and Y. The dot data thus generated by the print controller 274 is stored in the image buffer memory (not shown).

The head driver 278 outputs a drive signal for driving the actuators corresponding to the respective nozzles of the head 250 on the basis of the print data supplied from the print controller 274 (in other words, dot data stored in the image buffer memory 276). The head driver 278 may also incorporate a feedback control system for maintaining uniform drive conditions of the heads.

By applying a drive signal output from the head driver 278 to the head 250 in this way, ink is ejected from the corresponding nozzles. An image is formed on a recording medium 124 by controlling ink ejection from the head 250 while conveying the recording medium 124 at a prescribed speed. The inkjet recording apparatus 100 shown in the present embodiment employs a drive method in which a common drive power waveform signal is applied to the piezo actuators 258 of the head 250 (head modules), in units of one module, and ink is ejected from the nozzles 251 corresponding to the respective piezo actuators 258 by turning switching elements (not illustrated) connected to the individual electrodes of the piezo actuators 258 on and off, in accordance with the ejection timing of the respective piezo actuators 258.

The portion of the head driver 278 and the print control unit 274 (built into the image buffer memory) corresponds to the head control unit 60 illustrated in FIG. 18. Furthermore, the system controller 272 in FIG. 23 corresponds to an upper-level data control unit 80 which is illustrated in FIG. 18.

The treatment liquid deposition control unit 284 controls the operation of the treatment liquid application apparatus 156 (see FIG. 19) in accordance with instructions from the system controller 272. The drying control unit 286 controls the operation of the solvent drying apparatus 178 (see FIG. 19) in accordance with instructions from the system controller 272.

The fixing control unit 288 controls the operation of a fixing pressurization unit 299 which is constituted by the halogen heater 186 and the fixing roller 188 (see FIG. 19) of the fixing unit 120 in accordance with instructions from the system controller 272.

As described with reference to FIG. 19, the in-line sensor 190 is a block including an image sensor, reads in the image printed on the recording medium 124, performs required signal processing operations and the like so as to determine the print situation (presence/absence of ejection, variation in droplet ejection, optical density, and the like), and provides the system controller 272 and the print controller 274 with these determination results.

The print controller 274 implements various corrections (such as ejection failure correction and density correction) with respect to the head 250, on the basis of the information obtained from the in-line sensor 190, and it also implements control for carrying out cleaning operations (nozzle restoring operations), such as preliminary ejection, suctioning, or wiping, as and when necessary.

### Modification Examples

In the embodiment described above, an inkjet recording apparatus based on a method which forms an image by ejecting ink droplets directly onto the recording medium 124 (direct recording method) is described above, but the application of the present invention is not limited to this, and the present invention can also be applied to an image forming apparatus of an intermediate transfer type which provisionally forms an image (primary image) on an intermediate transfer body, and then performs final image formation by transferring the image onto recording paper in a transfer unit.

Furthermore, in the embodiments described above, an inkjet recording apparatus using a page-wide full-line type head having a nozzle row of a length corresponding to the full width of the recording medium (a single-pass image forming apparatus which completes an image by a single sub-scanning action) is described above, but the application of the present invention is not limited to this and the present invention can also be applied to an inkjet recording apparatus which performs image recording by means of a plurality of head scanning actions while moving a short recording head, such as a serial head (shuttle scanning head), or the like.

### Device for Causing Relative Movement of Head and Paper

In the embodiment described above, an example is given in which a recording medium is conveyed with respect to a stationary head, but in implementing an embodiment of the present invention, it is also possible to move a head with respect to a stationary recording medium (image formation receiving medium).

### Recording Medium

A “recording medium” is a general term for a medium on which dots are recorded by droplets ejected from an inkjet head, and this includes various terms, such as print medium, recording medium, image forming medium, image receiving medium, ejection receiving medium, and the like. In implementing an embodiment of the present invention, there are no particular restrictions on the material or shape, or other features, of the recording medium, and it is possible to employ various different media, irrespective of their material or shape, such as continuous paper, cut paper, seal paper, OHP sheets or other resin sheets, film, cloth, nonwoven cloth, a printed substrate on which a wiring pattern, or the like, is formed, or a rubber sheet.

### Application Examples of the Present Invention

In the embodiment described above, application to an inkjet recording apparatus for graphic printing is described above, but the scope of application of the present invention is not limited to this example. For example, the present invention can also be applied widely to inkjet systems which obtain various shapes or patterns using liquid function material, such as a wire printing apparatus which forms an image of a wire pattern for an electronic circuit, manufacturing apparatuses for various devices, a resist printing apparatus which uses resin liquid as a functional liquid for ejection, a color filter manufacturing apparatus, a fine structure forming apparatus for forming a fine structure using a material for material deposition, or the like.

### Appendix

As has become evident from the detailed description of the embodiments given above, the present specification includes disclosure of various technical ideas including the inventions described below.

An aspect of the invention is directed to a drive apparatus for a liquid ejection head, the drive apparatus comprising a drive signal generating device for generating a drive signal to operate an ejection energy generating element provided so as to correspond to a nozzle of the liquid ejection head, the drive signal being supplied to the ejection energy generating element so that a liquid droplet is caused to be ejected from the nozzle, wherein: the drive signal includes a plurality of ejection pulses for performing a plurality of ejection operations during one recording period, in a remaining pulse sequence excluding a final pulse of the plurality of ejection pulses, a voltage amplitude of a subsequent pulse is smaller than a voltage amplitude of a preceding pulse, and the final pulse has a largest voltage amplitude, of the plurality of ejection pulses.

According to this aspect of the invention, an initial droplet is ejected relatively strongly by a leading ejection pulse, and subsequent droplets are ejected relatively weakly thereafter, with the exception of the final droplet. According to the final pulse, a droplet is ejected most strongly compared with the other, preceding pulses, so as to merge with the preceding droplets. By this means, it is possible to achieve a good state of flight and attain a target droplet volume and droplet speed, while lowering the voltage required in relation to the droplet volume.

Desirably, the voltage amplitudes of subsequent pulses become gradually smaller in the remaining pulse sequence excluding the final pulse of the plurality of ejection pulses of the drive signal.

Meniscus vibration due to a preceding pulse can be used for the second and subsequent ejection operations. By gradually reducing the voltage amplitude (wave height) of the subsequent pulses, it is possible to gradually weaken the ejection energy of the consecutive ejection shots.

Desirably, the drive signal generating device is capable of generating a first drive signal as the drive signal which includes N ejection pulses (where N is an integer not less than 3) during one recording period, and a second drive signal in which M ejection pulses (where M is an integer not less than 1) are added before the N ejection pulses constituting the first drive signal, the added M ejection pulses being pulses having voltage amplitudes smaller than a voltage amplitude of a leading pulse of the N ejection pulses.

According to this mode, ejection of different droplet volumes is possible, and the ejection speeds of respective droplet types can be mutually aligned.

Desirably, ejection of different droplet volumes is possible by selecting and supplying to the ejection energy generating element, K ejection pulses (where K is an integer not less than 1 and not more than M+N) from a trailing end of the second drive signal which includes the M+N ejection pulses during one recording period.

In the case of a composition where the waveform of the second drive signal contains a waveform of a drive signal for a droplet type having a smaller droplet volume than that produced by the second drive signal (for instance, the waveform of a first drive signal, or the like), drive waveforms corresponding to a plurality of droplet types are obtained by selecting ejection pulses from the trailing end of the waveform.

Another aspect of the invention is directed to a drive apparatus for a liquid ejection head, the drive apparatus comprising a drive signal generating device for generating a drive signal to operate an ejection energy generating element provided so as to correspond to a nozzle of the liquid ejection head, the drive signal being supplied to the ejection energy generating element so that a liquid droplet is caused to be ejected from the nozzle, wherein: the drive signal includes a plurality of ejection pulses for performing a plurality of ejection operations during one recording period, and a remaining pulse sequence of the plurality of ejection pulses excluding a final pulse is configured in such a manner that, if the pulses in the remaining pulse sequence are extracted individually and compared in terms of ejection speeds produced by the respective pulses as obtained when used for single-shot ejection, then the ejection speeds produced by subsequent pulses in the remaining pulse sequence are slower than the ejection speeds produced by preceding pulses, and the final pulse causes ejection at a fastest ejection speed, compared with the ejection pulses preceding the final pulse in the remaining pulse sequence.

Similar actions and beneficial effects to the above can be also obtained by this mode.

Desirably, the drive signal is configured in such a manner that the ejection speeds produced by subsequent pulses become gradually slower in the remaining pulse sequence excluding the final pulse of the plurality of ejection pulses.

Since the meniscus vibration produced by the preceding pulses can be used for the second and subsequent ejection operations, it is possible to weaken the ejection force produced by the subsequent pulses. Furthermore, since the preceding droplets merge as a result of the final pulse, the ejection shape is also favorable.

Desirably, preceding droplets ejected by application of the ejection pulses preceding the final pulse are caused to combine during flight with a final droplet which is ejected by application of the final pulse.

Desirably, the arrangement of the respective ejection pulses is determined in such a manner that a plurality of droplets ejected in continuous fashion in one recording period combine together during flight to form a main droplet and then land on the medium.

Desirably, the drive signal is configured in such a manner that pulse intervals of subsequent pulses are gradually shifted from a resonance period Tc in the remaining pulse sequence excluding the final pulse of the plurality of ejection pulses.

By adjusting the waveform through combining the voltage amplitude and the pulse interval of the ejection pulses, it is possible readily to achieve a target droplet volume and droplet speed.

Desirably, the drive signal is configured in such a manner that pulse widths of subsequent pulses are gradually shifted from one half of a resonance period Tc in the remaining pulse sequence excluding the final pulse of the plurality of ejection pulses.

By adjusting the waveform through combining the voltage amplitude, the pulse width and the pulse interval of the ejection pulses, it is possible readily to achieve a target droplet volume and droplet speed.

Desirably, the drive signal is configured in such a manner that slope gradients of subsequent pulses are gradually decreased in the remaining pulse sequence excluding the final pulse of the plurality of ejection pulses.

By adjusting the waveform through combining the voltage amplitude and the pulse slope gradient of the ejection pulses, it is possible readily to achieve a target droplet volume and droplet speed.

Desirably, the drive signal includes a reverberation suppressing pulse after the final pulse of the plurality of ejection pulses.

By combining with the reverberation suppressing pulse, it is possible to further improve the ejection efficiency of the final pulse, as well as being able to reduce meniscus vibration (reverberation) after ejection of one recording period and thus stabilizing continuous recording operations.

Desirably, the drive apparatus comprises: a waveform data storage device which stores digital waveform data representing a waveform of the drive signal; a D/A converter which converts digital waveform data read out from the waveform data storage device, to an analog signal; and a switching device which controls a timing at which the drive signal generated via the D/A converter is applied to the ejection energy generating element.

Another aspect of the invention is directed to a liquid ejection apparatus comprising: a liquid ejection head having a nozzle for ejecting a liquid droplet, a pressure chamber connected to the nozzle, and an ejection energy generating element provided with the pressure chamber; and any one of the drive apparatuses for a liquid ejection head described above, causing the liquid droplet to be ejected from the nozzle of the liquid ejection head.

A liquid ejection apparatus can be achieved by combining any one of the drive apparatuses for a liquid ejection head relating to the above, and a liquid ejection head which operates by receiving the supply of a drive signal from the drive apparatus.

Another aspect of the invention is directed to an inkjet recording apparatus comprising: an inkjet head having a nozzle for ejecting a liquid droplet, a pressure chamber connected to the nozzle, and an ejection energy generating element provided with the pressure chamber; and any one of the drive apparatuses described above for causing the liquid droplet to be ejected from the nozzle of the inkjet head.

What is claimed is:

1. A drive apparatus for a liquid ejection head, the drive apparatus comprising a drive signal generating device configured to generate a drive signal to operate an ejection energy generating element provided so as to correspond to a pressure chamber connected to a nozzle of the liquid ejection head, the drive signal being supplied to the ejection energy generating element so that a liquid droplet is caused to be ejected from the nozzle, wherein:
the drive signal includes a plurality of ejection pulses configured to perform a plurality of ejection operations during one recording period;
a remaining pulse sequence of the plurality of ejection pulses excluding a final pulse is configured in such a manner that, if the pulses in the remaining pulse sequence are extracted individually and compared in terms of ejection speeds produced by the respective pulses as obtained when used for single-shot ejection, then the ejection speeds produced by subsequent pulses in the remaining pulse sequence are slower than the ejection speeds produced by preceding pulses, and the final pulse causes ejection at a fastest ejection speed, compared with the ejection pulses preceding the final pulse in the remaining pulse sequence;
the drive signal includes a reverberation suppressing pulse after the final pulse of the plurality of ejection pulses;
the final pulse is combined with the reverberation suppressing pulse; and
a potential difference in a signal element for compressing the pressure chamber to eject a final droplet by application of the final pulse is larger than a potential difference in a signal element of the final pulse for expanding the pressure chamber.

2. The drive apparatus as defined in claim 1, wherein the drive signal is configured in such a manner that the ejection speeds produced by subsequent pulses become gradually slower in the remaining pulse sequence excluding the final pulse of the plurality of ejection pulses.

3. The drive apparatus as defined in claim 1, wherein preceding droplets ejected by application of the ejection pulses preceding the final pulse are caused to combine during flight with the final droplet.

4. The drive apparatus as defined in claim 1, wherein the drive signal is configured in such a manner that pulse intervals of subsequent pulses are gradually shifted from a resonance period Tc in the remaining pulse sequence excluding the final pulse of the plurality of ejection pulses.

5. The drive apparatus as defined in claim 1, wherein the drive signal is configured in such a manner that pulse widths of subsequent pulses are gradually shifted from one half of a resonance period Tc in the remaining pulse sequence excluding the final pulse of the plurality of ejection pulses.

6. The drive apparatus as defined in claim 1, wherein the drive signal is configured in such a manner that slope gradients of subsequent pulses are gradually decreased in the remaining pulse sequence excluding the final pulse of the plurality of ejection pulses.

7. A liquid ejection apparatus comprising:
a liquid ejection head having a nozzle configured to eject a liquid droplet, a pressure chamber connected to the nozzle, and an ejection energy generating element provided with the pressure chamber; and
the drive apparatus as defined in claim 1 configured to cause the liquid droplet to be ejected from the nozzle of the liquid ejection head.

8. An inkjet recording apparatus comprising:
an inkjet head having a nozzle configured to eject a liquid droplet, a pressure chamber connected to the nozzle, and an ejection energy generating element provided with the pressure chamber; and
the drive apparatus as defined in claim 1 configured to cause the liquid droplet to be ejected from the nozzle of the inkjet head.
